(19) United States
(12) Patent Application Publication
(10) Pub. No.: US 2023/0064410 A1
(43) Pub. Date: Mar. 2, 2023

(54) PROCEDURES FOR FAILURE TO HANDLE CONFIGURATION DURING RRC RELEASE

(71) Applicant: Telefonaktiebolaget LM Ericsson (publ), Stockholm (SE)

(72) Inventors: Oumer Teyeb, MONTRÉAL (CA); Icaro Leonardo Da Silva, SOLNA (SE)

(21) Appl. No.: 17/792,498

(22) PCT Filed: Jan. 22, 2021
(86) PCT No.: PCT/SE2021/050037

§ 371 Date: Jul. 13, 2022

Related U.S. Application Data
(60) Provisional application No. 62/976,237, filed on Feb. 13, 2020.

(51) Int. Cl. H04W 76/27; H04W 76/38

(52) U.S. Cl. CPC H04W 76/27; H04W 76/38

(57) ABSTRACT

A method of operating a wireless device in a communication network includes receiving a message that indicates to the wireless device to enter a dormant state and that includes a configuration, determining that the wireless device is unable to comply with the configuration, and responsive to determining that the wireless device is unable to comply with the configuration, performing a recovery action. A method of operating a wireless network node includes sending an RRC release message instructing a wireless device to transition to a dormant state, the RRC release message including a configuration to be applied by the wireless device, and receiving a confirmation message indicating that the wireless device has properly applied the configuration, has not applied the configuration, or has partially applied the configuration. Related wireless devices and network nodes are disclosed.

### FIELD

The present disclosure relates generally to communications, and more particularly to communication methods and related devices and nodes supporting wireless communications.

### BACKGROUND

In LTE/NR, the Radio Resource Control (RRC) protocol is used to configure/setup and maintain the radio connection between the user equipment (UE) and the base station (eNB/gNB). When the UE receives an RRC message from the eNB/gNB, it will apply the configuration, and if this succeeds, the UE generates an RRC complete message and sends it to the eNB/gNB. The term “compile” is sometimes used to refer to the application of the configuration by the UE.

Since LTE Release-8, three Signaling Radio Bearers (SRBs), namely SRB0, SRB1 and SRB2 have been available for the transport of RRC and Non Access Stratum (NAS) messages between the UE and eNB. A new SRB, known as SRB1 bis, was also introduced in rel-13 for supporting DoNAS (Data Over NAS) in NB-IoT.

SRB0 is for RRC messages using the CCCH logical channel, and it is used for handling RRC connection setup, RRC connection resume and RRC connection re-establishment messages. Once the UE is connected to the eNB (i.e. RRC connection setup or RRC connection reestablishment/resume has succeeded), SRB1 is used for handling RRC messages (which may include a piggybacked NAS message) as well as for NAS messages prior to the establishment of SRB2, all using the DCCH logical channel.

SRB2 is used for RRC messages which include logged measurement information as well as for NAS messages, all using the DCCH logical channel. SRB2 has a lower priority than SRB1, because logged measurement information and NAS messages can be lengthy and could cause the blocking of more urgent and smaller SRB1 messages. SRB2 is always configured by E-UTRAN after security activation.

### SUMMARY

A method of operating a wireless device in a communication network according to some embodiments includes receiving a message that indicates to the wireless device to enter a dormant state, wherein the message includes a configuration, determining that the wireless device is unable to comply with the configuration included in the message, and responsive to determining that the wireless device is unable to comply with the configuration included in the message, performing a recovery action.

The message may include at least one of a RRCRelease message and a RRCConnectionRelease message. The configuration may refer to a procedure to be performed while the UE is in dormant state.

The configuration may refer to a field that is associated with an information element included in the message. The field may include at least one of: redirectedCarrierInfo of IE RedirectedCarrierinfo, cellReselectionPriorities of IE CellReselectionPriorities, suspendConfig of IE SuspendConfig, deprioritisationReq of IE SEQUENCE { deprioritisationType ENUMERATED {frequency, nr}, deprioritisationTimer of IE ENUMERATED {min5, min10, min15, min30} }, measIdleConfig of IE MeasldleConfigDedicated, and/or any other configuration received in the message.

The configuration may include at least one of a measurement configuration for idle state measurements, a cell reselection configuration, a redirected carrier configuration, a suspend configuration, and a deprioritisation type configuration.

The dormant state may include at least one of RRC INACTIVE state, RRC_IDLE state, RRC_IDLE state with a stored context, any other state designed mainly for power savings at the UE, and/or any other state where the UE performs cell reselection.

Determining that the wireless device is unable to comply with the configuration included in the configuration included in the message may include determining that the wireless device is unable to comply with a portion of the configuration included in the message.

The message may include a plurality of configurations that include respective fields and information elements, and determining that the wireless device is unable to comply with the configuration included in the message may include determining that the wireless device is unable to comply with one of the fields and/or information elements in at least one of the plurality of configurations.

The recovery action may include at least one of performing an action upon going to RRC_IDLE state, determining a release cause associated to a failure that is indicated to upper layers, responsive to a failure indication as release cause, triggering, by the upper layers, a recovery procedure in which the wireless device enters IDLE state and attempts to enter CONNECTED state via an RRC Connection Establishment, and initiating a connection re-establishment procedure, wherein the failure may include at least one of a suspend failure, a release failure, a resume failure, and a reconfiguration failure.

Receiving the message may be performed while the wireless device is in RRC_CONNECTED state, and performing the recovery action may be based on determining whether access stratum, AS, security has been activated. Responsive to determining that AS security has not been activated, the recovery action may be performed upon going to RRC_IDLE state, and responsive to determining that AS security has been activated and that a signalling radio bearer and at least one data radio bearer have not been setup, the recovery action may be performed upon going to RRC_IDLE state with a release cause indicating a failure.

The method may further include initiating a connection re-establishment procedure in response to determining that AS has been activated and that at least one data radio bearer has been set up.

Receiving the message may be performed while the wireless device is in RRC_INACTIVE state.

The message may cause a protocol error at the wireless device that corresponds to a generic error handling procedure that specifies that the wireless device ignore the message.

Responsive to the wireless device being unable to comply with any part of the configuration included in the message, the wireless device may not apply any of the configuration.

The method may further include, responsive to the wireless device being unable to comply with a portion of the configuration included in the message, applying a portion of the configuration that the wireless device can comply with and logging an indication regarding which portion of the configuration that the wireless device cannot comply with.

The method may further include causing a message to be sent to the communication network that includes an identity of the portion of the configuration that the wireless device cannot comply during and/or after a recovery operation.

A method of operating a wireless network node according to some embodiments includes transmitting a message that indicates to a wireless device to enter a dormant state, where the message includes a configuration, and receiving an indication from the wireless device that it is unable to comply with at least a part of the configuration included in the message.

The may further include refraining from setting the configuration in the wireless device in connection with a subsequent suspend or release procedure for the wireless device.

The network node may include a radio access network node or a core network node.

A method according to some embodiments of operating a wireless device that has established a radio resource control, RRC, connection with a network node in a communication network and operating in CONNECTED state includes receiving an RRC release message from the network node, instructing the wireless device to transition to a dormant state, the RRC release message including a configuration containing one or more of a configuration related to performing/reporting of early measurements, a configuration related to suspension/resumption of the connection, and/or a configuration related to redirection to other cells/frequencies.

The method may further include determining whether the wireless device is able to apply the configuration.

The method may further include, responsive to determining that the wireless device was not able to apply at least a part of the configuration, transmitting a confirmation message indicating that the wireless device has not applied the configuration or that the wireless device has partially applied the configuration.

The method may further include applying the configuration responsive to determining that the wireless device was able to apply the configuration, sending a confirmation message to the network signifying the wireless device has applied the configuration, and transitioning to IDLE state or INACTIVE state, depending on the received configuration.

Notifying the network node of the inability of the wireless device to apply at least a part of the configuration may include sending a confirmation message to the network node with an indication of a failure cause indicating that the wireless device was not able to apply the configuration.

The failure cause may include a generic cause or a detailed cause indicating which part of the configuration the wireless device was not able to apply.

The wireless device may remain in CONNECTED state after notifying the network node of the inability of the wireless device to apply at least a part of the configuration.

Notifying the network of the inability of the wireless device to apply at least a part of the configuration may include triggering a radio link failure procedure.

If the inability of the wireless device to apply the configuration was only partial, the wireless device may provide the network node with a confirmation message indicating the part of the configuration that that the wireless device was unable to apply.

The wireless device may apply a part of the configuration that was valid and transitions to IDLE or INACTIVE state.

The wireless device may locally store a failure reason, apply a part of the configuration that was valid and transition to IDLE or INACTIVE state.

The method may further include sending an RRC resume request message indicating a cause for the resumption of the connected state upon transitioning to a connected state.

Responsive to the wireless device not being able to apply a part of the configuration that was received in the RRC release message, the wireless device may include an indication that it has not applied that in a resume request message to the network node.

The indication may be sent in a resume complete message.

A wireless device according to some embodiments includes processing circuitry, and a memory coupled with the processing circuitry, wherein the memory includes instructions that when executed by the processing circuitry causes the wireless device to perform operations of receiving a message that indicates to the wireless device to enter a dormant state, wherein the message includes a configuration, determining that the wireless device is unable to comply with the configuration included in the message, and responsive to determining that the wireless device is unable to comply with the configuration included in the message, performing a recovery action.

A wireless device according to some embodiments is adapted to perform operations of receiving a message that indicates to the wireless device to enter a dormant state, wherein the message includes a configuration, determining that the wireless device is unable to comply with the configuration included in the message, and responsive to determining that the wireless device is unable to comply with the configuration included in the message, performing a recovery action.

A computer program product according to some embodiments may include a non-transitory storage medium including program code to be executed by processing circuitry of a wireless device, whereby execution of the program code causes the wireless device to perform operations including receiving a message that indicates to the wireless device to enter a dormant state, wherein the message includes a configuration, determining that the wireless device is unable to comply with the configuration included in the message, and responsive to determining that the wireless device is unable to comply with the configuration included in the message, performing a recovery action.

A wireless device according to some embodiments includes processing circuitry, and a memory coupled with the processing circuitry, wherein the memory includes instructions that when executed by the processing circuitry causes the wireless device to perform operations of receiving an RRC release message from the network node, instructing the wireless device to transition to a dormant state, the RRC release message including a configuration containing one or more of a configuration related to performing/reporting of early measurements, a configuration related to suspension/resumption of the connection, and/or a configuration related to redirection to other cells/frequencies.

A wireless device according to some embodiments is adapted to perform operations of receiving an RRC release message from the network node, instructing the wireless device to transition to a dormant state, the RRC release message including a configuration containing one or more of a configuration related to performing/reporting of early measurements, a configuration related to suspension/resumption of the connection, and/or a configuration related to redirection to other cells/frequencies.

A computer program product according to some embodiments may include a non-transitory storage medium including program code to be executed by processing circuitry of a wireless device, whereby execution of the program code causes the wireless device to perform operations including receiving an RRC release message from the network node, instructing the wireless device to transition to a dormant state, the RRC release message including a configuration containing one or more of a configuration related to performing/reporting of early measurements, a configuration related to suspension/resumption of the connection, and/or a configuration related to redirection to other cells/frequencies.

A method according to some embodiments of operating a wireless network node that has established a radio resource control, RRC, connection with a wireless device includes sending an RRC release message from the network node, instructing the wireless device to transition to a dormant state, the RRC release message including a configuration to be applied by the wireless device, and receiving from the wireless device a confirmation message indicating that the wireless device has properly applied the configuration, the wireless device has not applied the configuration, or the wireless device has partially applied the configuration.

The method may further include receiving an RRC resume request message from the wireless device indicating a cause for resumption of the RRC connection, and sending (1908) an RRC resume message to the wireless device in response to the RRC resume request.

The configuration may include one or more of a configuration related to performing/reporting of early measurements, a configuration related to the suspension/resumption of the connection, and/or a configuration related to redirection to other cells/frequencies.

In case of partial application or not applying the configuration at all, the method may further include receiving a confirmation message from the wireless device including a failure cause value.

The RRC resume request message may include an indication that the wireless device has not applied some or all of the configuration that was received in the RRC release message.

The method may further include receiving a resume complete message from the wireless device that may include an indication that the wireless device has not applied some or all of the configuration that was received in the RRC release message.

A radio access network, RAN, node according to some embodiments may include processing circuitry, and a memory coupled with the processing circuitry, wherein the memory may include instructions that when executed by the processing circuitry causes the RAN node to perform operations of sending an RRC release message from the network node, instructing the wireless device to transition to a dormant state, the RRC release message including a configuration to be applied by the wireless device, and receiving from the wireless device a confirmation message indicating that the wireless device has properly applied the configuration, the wireless device has not applied the configuration, or the wireless device has partially applied the configuration.

A radio access network, RAN, node according to some embodiments is adapted to perform operations of sending an RRC release message from the network node, instructing the wireless device to transition to a dormant state, the RRC release message including a configuration to be applied by the wireless device, and receiving from the wireless device a confirmation message indicating that the wireless device has properly applied the configuration, the wireless device has not applied the configuration, or the wireless device has partially applied the configuration.

A computer program product according to some embodiments may include a non-transitory storage medium including program code to be executed by processing circuitry of a radio access network, RAN, node, whereby execution of the program code causes the RAN node to perform operations of sending an RRC release message from the network node, instructing the wireless device to transition to a dormant state, the RRC release message including a configuration to be applied by the wireless device, and receiving from the wireless device a confirmation message indicating that the wireless device has properly applied the configuration, the wireless device has not applied the configuration, or the wireless device has partially applied the configuration.

A radio access network, RAN, node according to some embodiments may include processing circuitry, and a memory coupled with the processing circuitry, wherein the memory includes instructions that when executed by the processing circuitry causes the RAN node to perform operations of transmitting a message that indicates to a wireless device to enter a dormant state, where the message includes a configuration, and receiving an indication from the wireless device that it is unable to comply with at least a part of the configuration included in the message.

A radio access network, RAN, node according to some embodiments is adapted to perform operations of transmitting a message that indicates to a wireless device to enter a dormant state, where the message includes a configuration, and receiving an indication from the wireless device that it is unable to comply with at least a part of the configuration included in the message.

A computer program product according to some embodiments may include a non-transitory storage medium including program code to be executed by processing circuitry of a radio access network, RAN, node, whereby execution of the program code causes the RAN node to perform operations of transmitting a message that indicates to a wireless device to enter a dormant state, where the message includes a configuration, and receiving an indication from the wireless device that it is unable to comply with at least a part of the configuration included in the message.

Embodiments described herein may provide advantages including being assured that the wireless device (e.g., user equipments, UE) context that is kept at the network and wireless device will be the same when a wireless device gets suspended to a dormant state, preventing unexpected wireless device behavior. Additionally, it will be possible to identify incorrect/buggy network or wireless device implementation (e.g. if the network is configuring the wireless device beyond its capability, if the wireless device is indicating a capability that it is not able to fulfill). Further, when the wireless device is not able to comply with e.g. an RRCRelease message, the wireless device performs a recovery action to come back to the network so that both can get synchronized in terms of configuration(s) and/or context information they have. Additionally, embodiments may provide consistent behavior of wireless devices in networks employing equipments of different network vendors and consistent behavior of network nodes with wireless devices from different wireless device vendors.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic block diagram illustrating a LTE DC User Plane (UP) according to some embodiments.

FIG. 2 illustrates the UP and Control Plane (CP) architectures for LTE-NR tight interworking.

FIG. 3 is a block diagram illustrating a wireless device UE according to some embodiments of inventive concepts.

FIG. 4 is a block diagram illustrating a radio access network RAN node (e.g., a base station eNB/gNB) according to some embodiments of inventive concepts.

FIG. 5 is a block diagram illustrating a core network CN node (e.g., an AMF node, an SW node, etc.) according to some embodiments of inventive concepts.

FIG. 6 illustrates EN-DC protocol stack (CP).

FIG. 7 is a block diagram illustrating a UE state machine and state transitions in NR.

FIG. 8 illustrates the RRCRelease with suspend notification.

FIG. 9 illustrates the RRCResume message.

FIG. 10 illustrates the RRC connection resume, successful.

FIG. 11 illustrates the RRC connection resume fallback to RRC connection establishment, successful.

FIG. 12 illustrates the RRC connection resume followed by network release, successful.

FIG. 13 illustrates the RRC connection resume followed by network suspend, successful.

FIG. 14 illustrates the RRC connection resume, network reject condition.

FIGS. 15A, 15B and 15C are diagrams illustrating data flow corresponding to embodiments disclosed herein.

FIGS. 16-19 are flow charts that illustrate operations disclosed herein.

FIG. 20 is a block diagram of a wireless network in accordance with some embodiments.

FIG. 21 is a block diagram of a user equipment in accordance with some embodiments

FIG. 22 is a block diagram of a virtualization environment in accordance with some embodiments.

FIG. 23 is a block diagram of a telecommunication network connected via an intermediate network to a host computer in accordance with some embodiments.

FIG. 24 is a block diagram of a host computer communicating via a base station with a user equipment over a partially wireless connection in accordance with some embodiments.

FIG. 25 is a block diagram of methods implemented in a communication system including a host computer, a base station and a user equipment in accordance with some embodiments.

FIG. 26 is a block diagram of methods implemented in a communication system including a host computer, a base station and a user equipment in accordance with some embodiments.

FIG. 27 is a block diagram of methods implemented in a communication system including a host computer, a base station and a user equipment in accordance with some embodiments.

FIG. 28 is a block diagram of methods implemented in a communication system including a host computer, a base station and a user equipment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

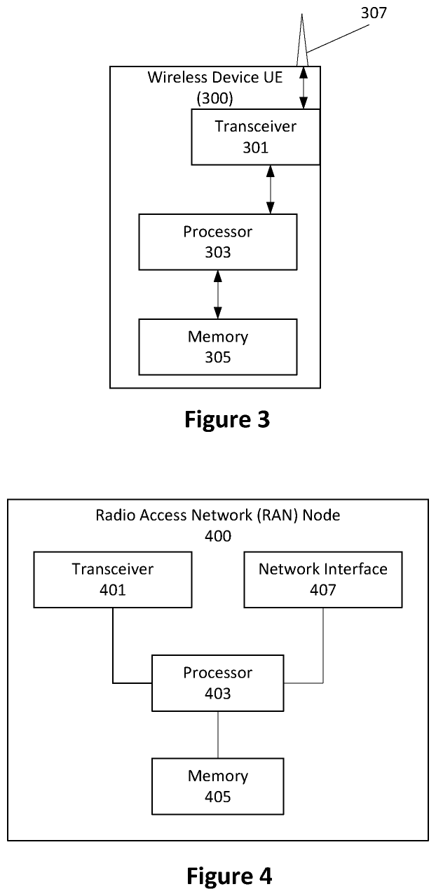

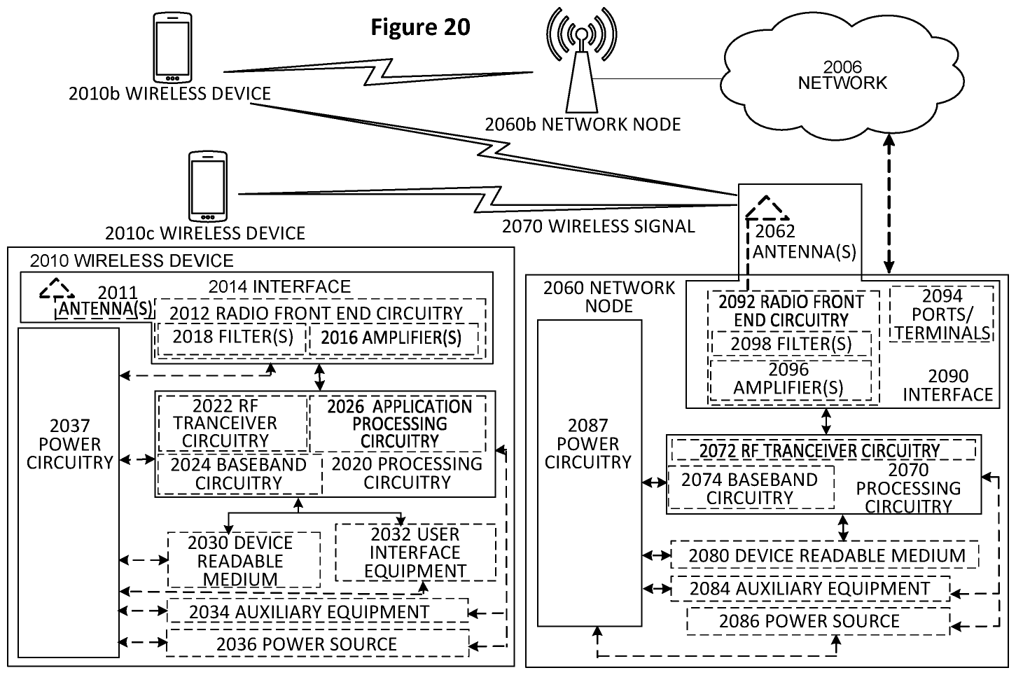

FIG. 3 is a block diagram illustrating elements of a wireless device UE 300 (also referred to as a mobile terminal, a mobile communication terminal, a wireless communication device, a wireless terminal, mobile device, a wireless communication terminal, user equipment, UE, a user equipment node/terminal/device, etc.) configured to provide wireless communication according to embodiments of inventive concepts. (Wireless device 300 may be provided, for example, as discussed below with respect to wireless device 2010 of FIG. 20.) As shown, wireless device UE may include an antenna 307 (e.g., corresponding to antenna 2011 of FIG. 20), and transceiver circuitry 301 (also referred to as a transceiver, e.g., corresponding to interface 2014 of FIG. 20) including a transmitter and a receiver configured to provide uplink and downlink radio communications with a base station(s) (e.g., corresponding to network node 2060 of FIG. 20, also referred to as a RAN node) of a radio access network. Wireless device UE may also include processing circuitry 303 (also referred to as a processor, e.g., corresponding to processing circuitry 2020 of FIG. 20) coupled to the transceiver circuitry, and memory circuitry 305 (also referred to as memory, e.g., corresponding to device readable medium 2030 of FIG. 20) coupled to the processing circuitry. The memory circuitry 305 may include computer readable program code that when executed by the processing circuitry 303 causes the processing circuitry to perform operations according to embodiments disclosed herein. According to other embodiments, processing circuitry 303 may be defined to include memory so that separate memory circuitry is not required. Wireless device UE may also include an interface (such as a user interface) coupled with processing circuitry 303, and/or wireless device UE may be incorporated in a vehicle.

As discussed herein, operations of wireless device UE may be performed by processing circuitry 303 and/or transceiver circuitry 301. For example, processing circuitry 303 may control transceiver circuitry 301 to transmit communications through transceiver circuitry 301 over a radio interface to a radio access network node (also referred to as a base station) and/or to receive communications through transceiver circuitry 301 from a RAN node over a radio interface. Moreover, modules may be stored in memory circuitry 305, and these modules may provide instructions so that when instructions of a module are executed by processing circuitry 303, processing circuitry 303 performs respective operations (e.g., operations discussed below with respect to Example Embodiments relating to wireless devices).

FIG. 4 is a block diagram illustrating elements of a radio access network RAN node 400 (also referred to as a network node, base station, eNodeB/eNB, gNodeB/gNB, etc.) of a Radio Access Network (RAN) configured to provide cellular communication according to embodiments of inventive concepts. (RAN node 400 may be provided, for example, as discussed below with respect to network node 2060 of FIG. 20.) As shown, the RAN node may include transceiver circuitry 401 (also referred to as a transceiver, e.g., corresponding to portions of interface 2090 of FIG. 20) including a transmitter and a receiver configured to provide uplink and downlink radio communications with mobile terminals. The RAN node may include network interface circuitry 407 (also referred to as a network interface, e.g., corresponding to portions of interface 2090 of FIG. 20) configured to provide communications with other nodes (e.g., with other base stations) of the RAN and/or core network CN. The network node may also include processing circuitry 403 (also referred to as a processor, e.g., corresponding to processing circuitry 2070) coupled to the transceiver circuitry, and memory circuitry 405 (also referred to as memory, e.g., corresponding to device readable medium 2080 of FIG. 20) coupled to the processing circuitry. The memory circuitry 405 may include computer readable program code that when executed by the processing circuitry 403 causes the processing circuitry to perform operations according to embodiments disclosed herein. According to other embodiments, processing circuitry 403 may be defined to include memory so that a separate memory circuitry is not required.

As discussed herein, operations of the RAN node may be performed by processing circuitry 403, network interface 407, and/or transceiver 401. For example, processing circuitry 403 may control transceiver 401 to transmit downlink communications through transceiver 401 over a radio interface to one or more mobile terminals UEs and/or to receive uplink communications through transceiver 401 from one or more mobile terminals UEs over a radio interface. Similarly, processing circuitry 403 may control network interface 407 to transmit communications through network interface 407 to one or more other network nodes and/or to receive communications through network interface from one or more other network nodes. Moreover, modules may be stored in memory 405, and these modules may provide instructions so that when instructions of a module are executed by processing circuitry 403, processing circuitry 403 performs respective operations (e.g., operations discussed below with respect to Example Embodiments relating to RAN nodes).

According to some other embodiments, a network node may be implemented as a core network CN node without a transceiver. In such embodiments, transmission to a wireless device UE may be initiated by the network node so that transmission to the wireless device is provided through a network node including a transceiver (e.g., through a base station or RAN node). According to embodiments where the network node is a RAN node including a transceiver, initiating transmission may include transmitting through the transceiver.

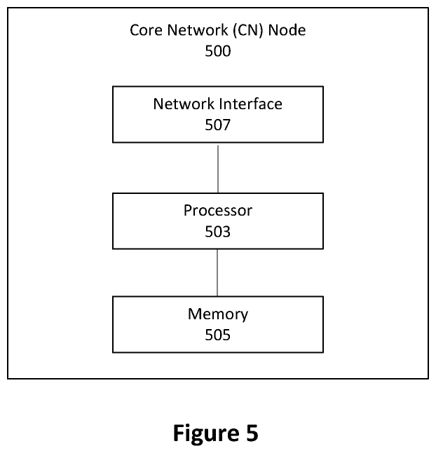

FIG. 5 is a block diagram illustrating elements of a core network CN node (e.g., an SMF node, an AMF node, etc.) of a communication network configured to provide cellular communication according to embodiments of inventive concepts. As shown, the CN node may include network interface circuitry 507 (also referred to as a network interface) configured to provide communications with other nodes of the core network and/or the radio access network RAN. The CN node may also include a processing circuitry 503 (also referred to as a processor) coupled to the network interface circuitry, and memory circuitry 505 (also referred to as memory) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the CN node may be performed by processing circuitry 503 and/or network interface circuitry 507. For example, processing circuitry 503 may control network interface circuitry 507 to transmit communications through network interface circuitry 507 to one or more other network nodes and/or to receive communications through network interface circuitry from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to core network nodes).

E-UTRAN supports Dual Connectivity (DC) operation whereby a multiple Rx/Tx UE in RRC_CONNECTED is configured to utilize radio resources provided by two distinct schedulers, located in two eNBs connected via a non-ideal backhaul over the X2 interface. eNBs involved in DC for a certain UE may assume two different roles: an eNB may either act as an MN (Master node) or as an SN (Secondary node). In DC a UE is connected to one MN and one SN.

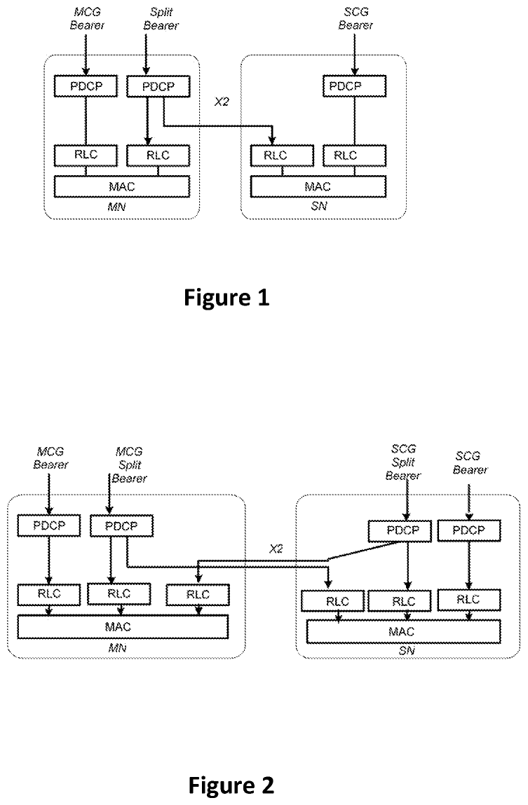

In LTE DC, the radio protocol architecture that a particular bearer uses depends on how the bearer is setup. Three bearer types exist: MCG (Master Cell Group) bearer, SCG (Secondary Cell Group) bearer and split bearers. RRC is located in MN and SRBs (Signaling Radio Bearers) are always configured as MCG bearer type and therefore only use the radio resources of the MN. For example, brief reference is made to FIG. 1, which is a schematic block diagram illustrating a LTE DC User Plane (UP) according to some embodiments.

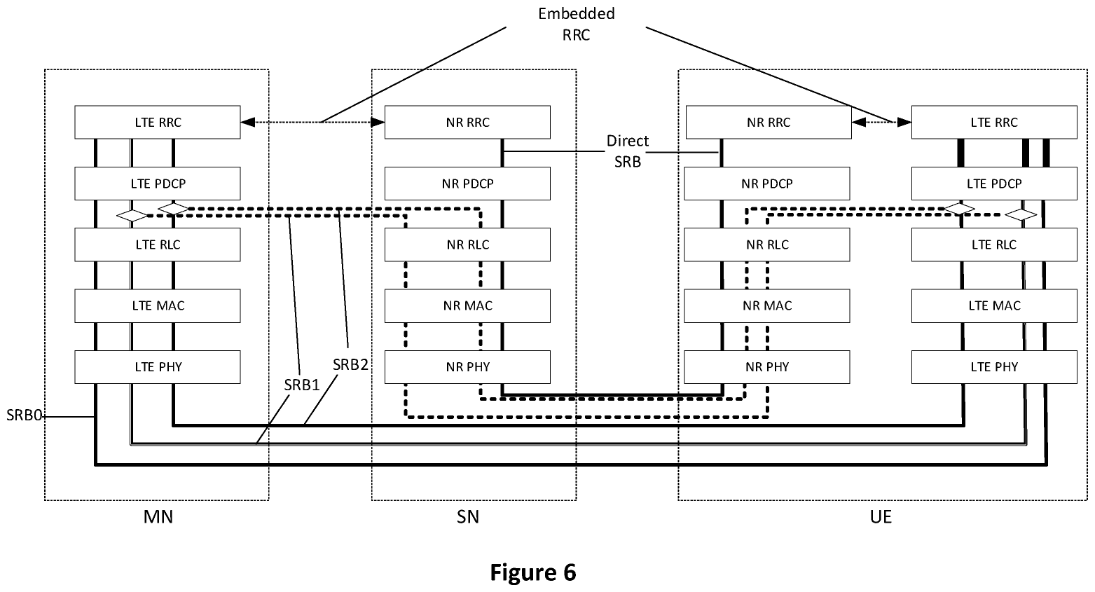

LTE-NR (New Radio) DC (also referred to as LTE-NR tight interworking) is currently being discussed and may provide changes from LTE DC including the introduction of split bearer from the SN (known as SCG split bearer), the introduction of split bearer for RRC, and the introduction of a direct RRC from the SN (also referred to as SCG SRB, or SRB3). Examples are provided in FIG. 2, which illustrates the UP and Control Plane (CP) architectures for LTE-NR tight interworking. Additionally, FIG. 6 illustrates EN-DC protocol stack (CP).

The SN is sometimes referred to as SgNB (where gNB is an NR base station), and the MN as MeNB in case the LTE is the master node and NR is the secondary node. In the other case where NR is the master and LTE is the secondary node, the corresponding terms are SeNB and MgNB.

Split RRC messages are mainly used for creating diversity, and the sender can decide to either choose one of the links for scheduling the RRC messages, or it can duplicate the message over both links. In the downlink, the path switching between the MCG or SCG legs or duplication on both is left to network implementation. On the other hand, for the UL, the network configures the UE to use the MCG, SCG or both legs. The terms “leg” and “path” are used interchangeably throughout this document.

Regarding a background RRC connection resume in LTE, a mechanism was introduced for the UE to be suspended by the network in a suspended state similar to RRC IDLE but with the difference that the UE stores the Access Stratum (AS) context or RRC context. This makes it possible to reduce the signaling when the UE is becoming active again by resuming the RRC connection, instead of as prior to establish the RRC connection from scratch. Reducing the signaling could have several benefits, such as reduced latency (e.g. for smart phones accessing Internet) and reduced signaling leads to reduce battery consumption for machine type devices sending very little data.

The Rel-13 solution is based on that the UE sends a RRCConnectionResumeRequest message to the network and in response may receive an RRCConnectionResume from the network. The RRCConnectionResume is not encrypted but integrity protected.

The resume procedure in LTE can be found in the RRC specifications (TS 36.331). As the UE performing resume is in RRC_IDLE (with suspended AS context), that triggers a transition from RRC_IDLE to RRC_CONNECTED. Hence, that is modelled in the specifications in the same subclause that captures the RRC connection establishment (subclause 5.3.3 RRC connection establishment).

Regarding a background RRC connection resume in NR and LTE, the RRC state model is updated in NR (and in eLTE, i.e. LTE connected to 5GC) and a new RRC_INACTIVE state is introduced in addition to the existing RRC_IDLE and RRC_CONNECTED states inherited from LTE. In RRC_INACTIVE, the UE context from the previous RRC connection is stored in the RAN and is re-used the next time an RRC connection is established. The UE context includes information such as the UE security configuration, configured radio bearers etc. By storing the UE context in the RAN one avoids the signaling required for security activation and bearer establishment which is normally required when transitioning from RRC IDLE to RRC_CONNECTED. This may improve latency and reduce the signaling overhead.

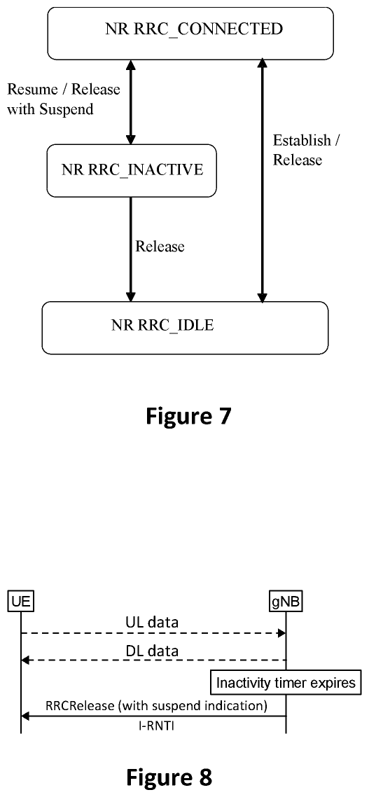

Reference is now made to FIG. 7, which is a block diagram illustrating a UE state machine and state transitions in NR. RRC_INACTIVE mode is realized by introducing two new procedures “RRC connection suspend” (also called RRC connection release with SuspendConfig) and “RRC connection resume”. The gNB suspends a connection and moves the UE from RRC_CONNEC IED to RRC_INACTIVE by sending a RRC release message with suspend indication (or configuration) to the UE. This may happen for example after the UE has been inactive for a certain period which causes the gNB internal inactivity timer to expire. Both the UE and gNB stores the UE context and the associated identifier (referred to as I-RNTI). It has been recently updated that two identifiers will be configured in the suspend configuration, a long and short I-RNTI. The one to be used in resume depends on an indication from the network in system information of the cell the UE tries to resume in. The two I-RNTI identifiers were introduced to support scenarios when the UE is resuming in a cell which only gives the UE a small scheduling grant for the first UL message. For this purpose, also two different resume messages has been introduced namely RRCResumeRequest and RRCResumeRequest1. In the remainder of this document RRC resume request is used to refer to both messages.

At the next transition to RRC_CONNEC IED, the UE resumes the connection by sending a RRC resume request including the following information to the gNB which the UE attempts to resume the connection towards (note that it may be another cell/gNB compared to the cell/gNB where the connection was suspended):
The I-RNTI (either the long or short I-RNTI depending on the system information indication);
A security token (called resumeMAC-I in the specification) which is used to identify and verify the UE at RRC connection resume; and/or
An indication of the cause of the resume, e.g. mobile originated data.

Reference is made to FIG. 8, which illustrates the RRCRelease with suspend notification. The gNB which serves the cell in which the UE is resuming is sometimes referred to as the target gNB, while the gNB serving the cell in which the UE was suspended in is sometimes referred to as the source gNB. To resume the connection, the target gNB determines which gNB is the source gNB (considering the gNB part of the I-RNTI) and request that gNB to send the UE's context. In the request the target provides, among other things, the UE ID and security token received from the UE as well as the target cell Cell ID.

The source gNB then locates the UE context based on the I-RNTI and verifies the request based on the security token (see next section). If successful, the gNB forwards the UE context to the target gNB, which then responds to the UE with RRC resume to confirm the connection is being resumed. The RRC resume message may also contain configurations to reconfigure the radio bearers being resumed. Finally, the UE acknowledges the reception of the RRC re-establishment by sending RRC re-establishment complete.

Note that the described NR RRC resume procedure works in a similar way in LTE and eLTE (i.e. when LTE is connected to 5GC).

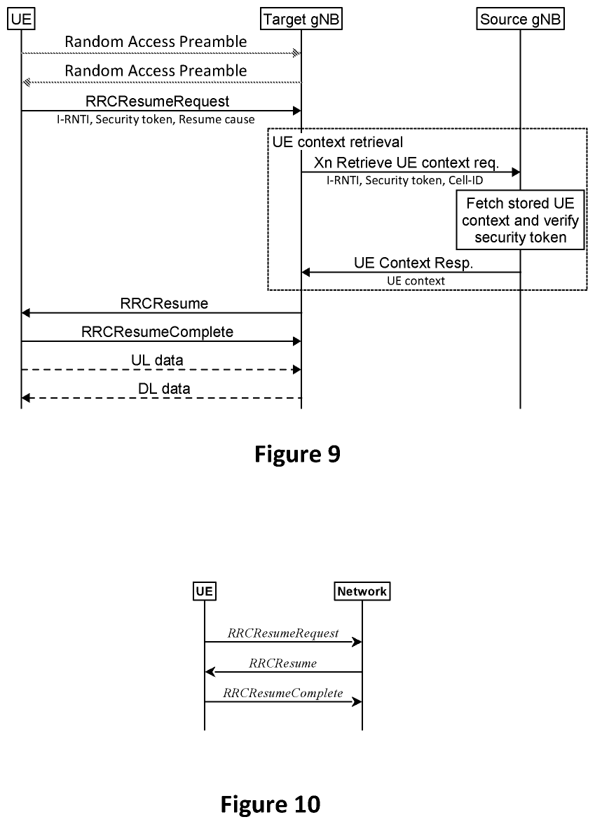

Reference is made to FIG. 9. In NR and in eLTE (LTE connected to 5GC) the RRCResume message is encrypted and integrity protected. That is done using new security keys, derived based on the stored AS security context. This new key derivation (sort of a key update) is done as part of the resume procedure, in particular as part of the transmission of the RRCResumeRequest (or RRCResumeRequestl).

It is not only the RRCResume message that may be sent in response to the RRCResumeRequest message. In NR and eLIE, after the UE sends an RRC Resume Request kind of message (e.g. RRCResumeRequest or RRCResumeRequestl) the UE may receive a message on SRB1 that should also be encrypted, and integrity protected, as described above:
RRCRelease with suspend configuration moving the UE to RRC_INACTIVE;
RRCRelease without suspend configuration moving the UE to RRC_IDLE;
RRCResume moving the UE to RRC_CONNECTED;

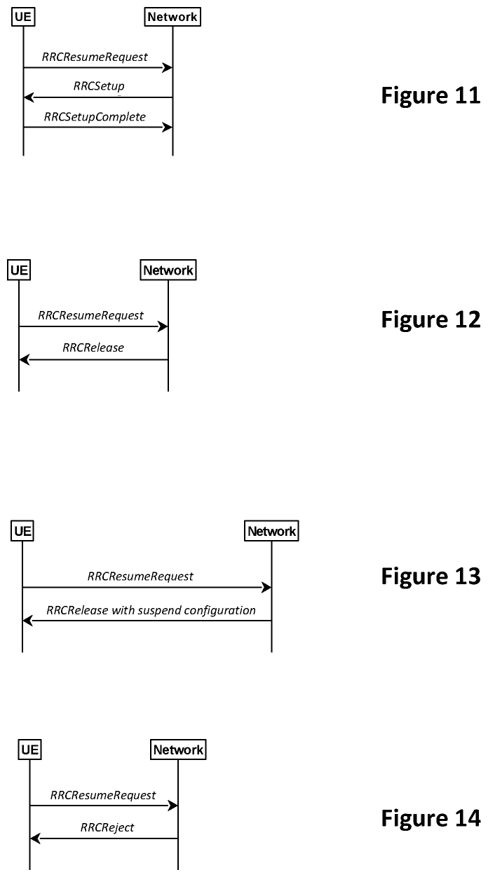

Other messages may also be transmitted, an RRCReject with wait timer or RRCSetup (fallback to RRC_IDLE) but on SRB0 (i.e. not encrypted or integrity protected). All these possible responses are shown as in the follow figures. Reference is made to FIG. 10, which illustrates the RRC connection resume, successful. Reference is made to FIG. 11, which illustrates the RRC connection resume fallback to RRC connection establishment, successful. Reference is made to FIG. 12, which illustrates the RRC connection resume followed by network release, successful. Reference is made to FIG. 13, which illustrates the RRC connection resume followed by network suspend, successful. Reference is made to FIG. 14, which illustrate the RRC connection resume, network reject condition.

Addressing reconfiguration failure, as discussed in the previous sections, upon successful application of the configuration received in an RRCReconfiguration or RRCResume message, the UE responds to the network with an RRCReconfigurationComplete or RRCResumeComplete message. That way, it is ensured that the configuration that is kept/used by the UE is the same as the UE context stored at the network and unpredictable UE behavior (e.g. UE using the previous configuration before the reception of that message while network assuming the UE has the new configuration, or vice versa), is prevented.

If the UE is unable to properly compile/apply the configuration received in RRCReconfiguration or RRCResume messages, the UE will not just refrain from applying the configuration, but will instead initiate a specified procedure to notify the network what happened. For the case of RRCReconfiguration, the Reconfiguration failure procedure is initiated, while for the RRCResume, the inability to comply with resume procedure is initiated.

In both LTE and NR, the UE can be sent to a dormant state (IDLE state in LTE/NR, IDLE with suspended state in LTE, INACTIVE state in LTE/NR) via the RRC Release message in NR or RRC Connection Release in LTE.

Before the introduction of suspended connection in LTE rel-13, the RRC Connection Release message was used to just to release the UE's RRC connection and only minimal information was included in that message as shown below (e.g. release cause; in case of redirection, which frequencies the UE should try to establish a connection to and their priority, etc.) The elements of the RRC Connection Release message are shown in Table 1 below.

TABLE 1
RRC Connection Release Message

| RRCConnectionRelease-r8-IEs ::= | SEQUENCE { | | |
|---|---|---|---|
| releaseCause | ReleaseCause, | | |
| redirectedCarrierInfo | RedirectedCarrierInfo | OPTIONAL, | -- Need |

ON

| | | | |
|---|---|---|---|
| idleModeMobilityControlInfo | IdleModeMobilityControlInfo | OPTIONAL, | -- Need |

OP

| | | |
|---|---|---|
| nonCriticalExtension | RRCConnectionRelease-v890-IEs | OPTIONAL |

}

| | |
|---|---|
| RRCConnectionRelease-v890-IEs ::= | SEQUENCE { |
| lateNonCriticalExtension | OCTET STRING (CONTAINING RRCConnectionRelease-v9e0-IEs) |

OPTIONAL,

| | | |
|---|---|---|
| nonCriticalExtension | RRCConnectionRelease-v920-IEs | OPTIONAL |

}
-- Late non critical extensions
RRCConnectionRelease-v9e0-IEs ::= SEQUENCE {

| | | | |
|---|---|---|---|
| redirectedCarrierInfo-v9e0 | RedirectedCarrierInfo-v9e0 | OPTIONAL, | -- Cond |

NoRedirect-r8

| | | | |
|---|---|---|---|
| idleModeMobilityControlInfo-v9e0 | IdleModeMobilityControlInfo-v9e0 | OPTIONAL, | -- Cond |

IdleInfoEUTRA

| | | |
|---|---|---|
| nonCriticalExtension | SEQUENCE { } | OPTIONAL |

}
-- Regular non critical extensions

| | |
|---|---|
| RRCConnectionRelease-v920-IEs ::= | SEQUENCE { |
| cellInfoList-r9 | CHOICE { |
| geran-r9 | CellInfoListGERAN-r9, |
| utra-FDD-r9 | CellInfoListUTRA-FDD-r9, |
| utra-TDD-r9 | CellInfoListUTRA-TDD-r9, |

...,

| | |
|---|---|
| utra-TDD-r10 | CellInfoListUTRA-TDD-r10 |

| | | |
|---|---|---|
| } | OPTIONAL, | -- Cond Redirection |

| | | |
|---|---|---|
| nonCriticalExtension | RRCConnectionRelease-v1020-IEs | OPTIONAL |

}

| RRCConnectionRelease-v1020-IEs ::= | SEQUENCE { | | |
|---|---|---|---|
| extendedWaitTime-r10 | INTEGER (1..1800) | OPTIONAL, | -- Need ON |

| | | |
|---|---|---|
| nonCriticalExtension | RRCConnectionRelease-v1320-IEs | OPTIONAL |

}

| IdleModeMobilityControlInfo ::= | SEQUENCE { | | |
|---|---|---|---|
| freqPriorityListEUTRA | FreqPriorityListEUTRA | OPTIONAL, | -- Need |

ON

| | | | |
|---|---|---|---|
| freqPriorityListGERAN | FreqsPriorityListGERAN | OPTIONAL, | -- Need |

ON

| | | | |
|---|---|---|---|
| freqPriorityListUTRA-FDD | FreqPriorityListUTRA-FDD | OPTIONAL, | -- Need |

ON

| | | | |
|---|---|---|---|
| freqPriorityListUTRA-TDD | FreqPriorityListUTRA-TDD | OPTIONAL, | -- Need |

ON

| | | | |
|---|---|---|---|
| bandClassPriorityListHRPD | BandClassPriorityListHRPD | OPTIONAL, | -- Need |

ON

| | | | |
|---|---|---|---|
| bandClassPriorityList1XRTT | BandClassPriorityList1XRTT | OPTIONAL, | -- Need |

ON

| t320 | ENUMERATED { | | |
|---|---|---|---|
| | min5, min10, min20, min30, min60, min120, min180, | | |
| | spare1} | OPTIONAL, | -- Need |

OR
...,

| | | |
|---|---|---|
| [[ freqPriorityListExtEUTRA-r12 | FreqPriorityListExtEUTRA-r12 | OPTIONAL |

```
  -- Need ON
  ]],
```

| | | |
|---|---|---|
| [[ freqPriorityListEUTRA-v1310 | FreqPriorityListEUTRA-v1310 | OPTIONAL, |

-- Need ON

| | | |
|---|---|---|
| freqPriorityListExtEUTRA-v1310 | FreqPriorityListExtEUTRA-v1310 | OPTIONAL |

```
  -- Need ON
  ]],
```

| | | | |
|---|---|---|---|
| [[ freqPriorityListNR-r15 | FreqPriorityListNR-r15 | OPTIONAL | -- Need |

ON
]]
}

| | |
|---|---|
| IdleModeMobilityControlInfo-v9e0 ::= | SEQUENCE { |
| freqPriorityListEUTRA-v9e0 | SEQUENCE (SIZE (1..maxFreq)) OF FreqPriorityEUTRA-v9e0 |

}

With the introduction of IDLE with suspended in rel-13 and later the INACTIVE state in NR/LTE in rel-15, the RRC Release (or RRC Connection Release in LTE) message is containing more and more configuration information such as: information related to suspension of the RRC connection (e.g. suspendConfig in NR that is the configuration the UE have to use later upon resuming the connection due to UL data arrival, paging due to DL data arrival, need to do reporting of periodic RAN area update, etc.); and information related to performing of early measurements while in IDLE/INACTIVE state (e.g. measIdleConfig in rel-15 LTE, and also agreed for rel-16 NR).

Specifically, the early measurement configuration can be a complex configuration that contains detailed information which is very dependent on UE capabilities such as the carriers that the UE has to perform during IDLE/INACTIVE sate and report on transition to connected state. Below, the current agreed early measurement configuration from the latest running NR rel-16 CR (R2-1915282) is shown.

The IE MeasldleConfig is used to convey information to UE about measurements requested to be done while in RRC_IDLE or RRC_INACTIVE. The MeasldleConfig IE is shown in Table 2 below.

TABLE 2
MeasIdleConfig information element

-- ASN1START
-- TAG-MEASIDLECONFIG-START
MeasIdleConfigSIB-r16 ::= SEQUENCE {

| | | | |
|---|---|---|---|
| measIdleCarrierListNR-r16 | NR-CarrierList-r16 | OPTIONAL, | -- Need |

FFS

| | | | |
|---|---|---|---|
| measIdleCarrierListEUTRA-r16 | EUTRA-CarrierList-r16 | OPTIONAL, | -- Need |

FFS
...
}
MeasIdleConfigDedicated-r16 :: = SEQUENCE {

| | | | |
|---|---|---|---|
| measIdleCarrierListNR-r16 | NR-CarrierList-r16 | OPTIONAL, | -- Need |

FFS

| | | | |
|---|---|---|---|
| measIdleCarrierListEUTRA-r16 | EUTRA-CarrierList-r16 | OPTIONAL, | -- Need |

FFS

| | |
|---|---|
| measIdleDuration-r16 | FFS-Value, |

...
}
NR-CarrierList-r16 ::= SEQUENCE (SIZE (1..maxFreqIdle-r16)) OF MeasIdleCarrierNR-r16
EUTRA-CarrierList-r16 ::= SEQUENCE (SIZE (1..maxFreqIdle-r16)) OF MeasIdleCarrierEUTRA-r16
Editor's note: how to capture the Validity Area is FFS

| MeasIdleCarrierNR-r16 ::= | SEQUENCE { | | |
|---|---|---|---|
| carrierFreqNR-r16 | ARFCN-ValueNR, | | |
| measCellListNR-r16 | CellListNR-r16 | OPTIONAL, | -- Need FFS |
| reportQuantities-r16 | ENUMERATED {rsrp, rsrq, both}, | | |
| qualityThreshold-r16 | SEQUENCE { | | |
| idleRSRP-Threshold-NR-r16 | RSRP-Range | OPTIONAL, | -- Need FFS |
| idleRSRQ-Threshold-NR-r16 | RSRQ-Range | OPTIONAL | -- Need FFS |

| | | |
|---|---|---|
| } | OPTIONAL, | -- Need FFS |

| ssbMeasConfig-r16 | SEQUENCE { | |
|---|---|---|
| frequencyBandList | MultiFrequencyBandListNR | OPTIONAL, |

| | | |
|---|---|---|
| nrofSS-BlocksToAverage-r16 | INTEGER (2..maxNrofSS-BlocksToAverage) | OPTIONAL, -- |

Need FFS

| | |
|---|---|
| absThreshSS-BlocksConsolidation-r16 | ThresholdNR |

OPTIONAL, -- Need FFS

| | |
|---|---|
| smtc-r16 | SSB-MTC |

OPTIONAL, -- Need FFS

| | |
|---|---|
| ssbSubcarrierSpacing-r16 | SubcarrierSpacing, |
| ssb-ToMeasure-r16 | SSB-ToMeasure |

OPTIONAL, -- Need FFS

| | |
|---|---|
| deriveSSB-IndexFromCell-r16 | BOOLEAN, |
| ss-RSSI-Measurement-r16 | SS-RSSI-Measurement |

```
OPTIONAL
      Editor's note: FFS if frequencyBandList and ssbSubcarrierSpacing should be defined together with the
      carrierFreqNR (i.e. outside the ssbMeasConfig structure)
```

| } | | OPTIONAL, | -- Cond FFS |
|---|---|---|---|
| beamMeasConfigIdle-r16 | BeamMeasConfigIdle-NR-r16 | OPTIONAL, | -- Need FFS |

...
}

| MeasIdleCarrierEUTRA-r16 ::= | SEQUENCE { | | |
|---|---|---|---|
| carrierFreqEUTRA-r16 | ARFCN-ValueEUTRA, | | |
| allowedMeasBandwidth-r16 | EUTRA-AllowedMeasBandwidth, | | |
| measCellListEUTRA-r16 | CellListEUTRA-r16 | OPTIONAL, | -- Need FFS |
| reportQuantities-r16 | ENUMERATED {rsrp, rsrq, both}, | | |
| qualityThreshold-r16 | SEQUENCE { | | |
| idleRSRP-Threshold-EUTRA-r16 | RSRP-RangeEUTRA | OPTIONAL, | -- Need FFS |
| idleRSRQ-Threshold-EUTRA-r16 | RSRQ-RangeEUTRA-r16 | OPTIONAL | -- Need FFS |

| | | |
|---|---|---|
| } | OPTIONAL, | -- Need FFS |

...
}

| | |
|---|---|
| CellListNR-r16 ::= | SEQUENCE (SIZE (1..maxCellMeasIdle-r16)) OF PCI-Range |
| CellListEUTRA-r16 ::= | SEQUENCE (SIZE (1..maxCellMeasIdle-r16)) OF EUTRA-PhysCellIdRange |

| BeamMeasConfigIdle-NR-r16 ::= | SEQUENCE { | | |
|---|---|---|---|
| reportQuantityRS-Indexes-r16 | ENUMERATED {rsrp, rsrq, both} | OPTIONAL, | -- Need FFS |

| | | |
|---|---|---|
| maxNrofRS-IndexesToReport-r16 | INTEGER (1..FFS) OPTIONAL, | -- Need FFS |

| | |
|---|---|
| includeBeamMeasurements-r16 | BOOLEAN |

}

| | |
|---|---|
| RSRQ-RangeEUTRA-r16 ::= | INTEGER (−30..46) |

-- TAG-MEASIDLECONFIG-STOP
-- ASN1STOP

Thus, it has become more likely since Rel-16 than the previous releases that the UE may not be able to comply with the configuration that it has received with the RRC Release message, as it happens to an RRCReconfiguration or RRCResume message. However, there is nothing specified concerning the UE behavior if that happens. Thus, it is possible that a network may have configured the UE with a certain configuration (e.g. early measurements) but the UE may not have been able to apply them and act accordingly (and since a complete message is not sent in response to the Release message, the network will never know for sure if the UE have applied them). It is not even clear that if the UE would run the procedure related to the reception of the RRCRelease message. Thus, the network may be expecting the UE to perform and report the early measurements, while the UE is not doing so. Or, prioritize carriers to be measured for cell reselection according to some dedicated priorities while T320 is running. Additionally, in situations like 2-step resume (i.e. when the resume request is responded with another release message putting the UE back to dormant state, which is typically performed when the UE sends a resume request just to send a periodic RAN area update), the network may try to change the early measurement configuration (e.g. release or reconfigure it), assuming that the UE has already applied the previous configuration, propagating further errors. In general terms, with RRC_INACTIVE more feature could be added to the UE depending on configurations in RRCRelease, which more and more would increase the chances the UE is unable to comply with it, leaving an unspecified behavior that can be ambiguous.

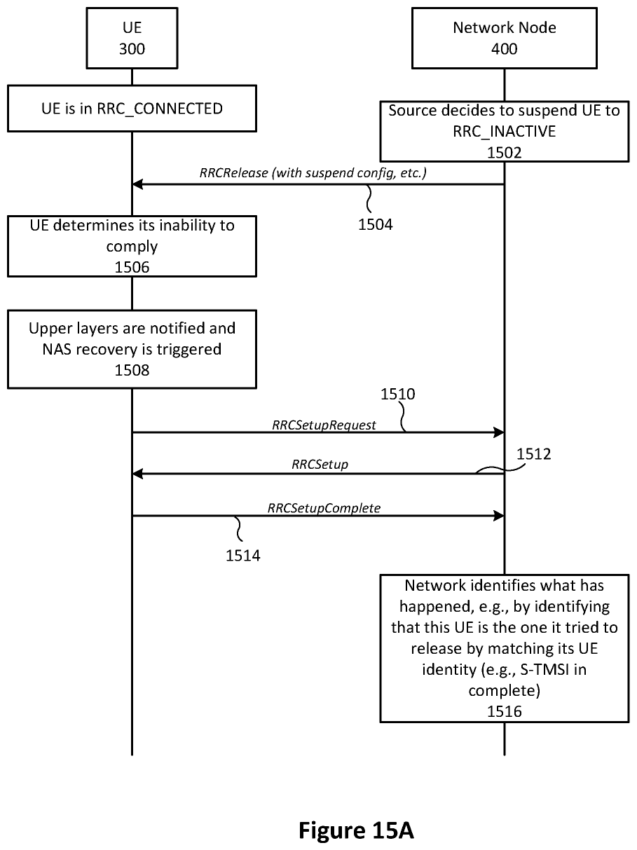

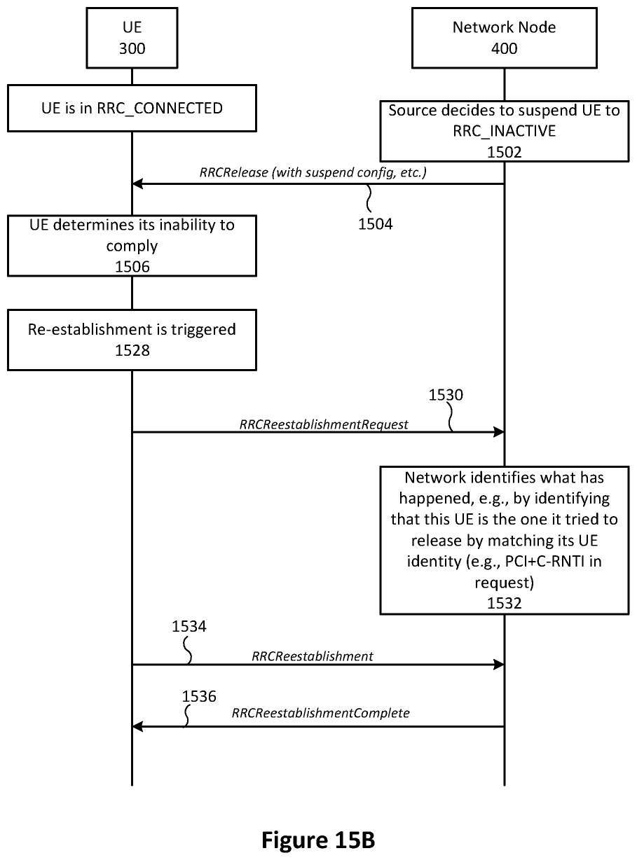

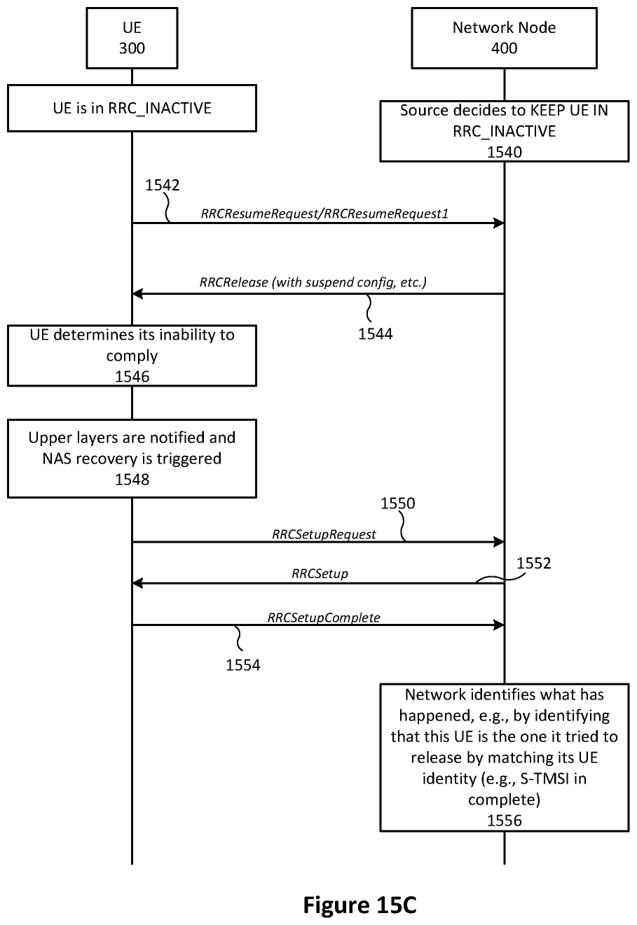

Reference is now made to FIGS. 15A, 15B and 15C, which are diagrams illustrating data flow corresponding to embodiments disclosed herein.

Referring to FIG. 15A, a network node 400 with which a UE 300 has an RRC connection, such as a serving gNB, determines to suspend the UE 300 to a dormant state, such as RRC_INACTIVE (block 1502). The network node 400 transmits an RRCRelease message 1504 to the UE 300. The RRCRelease message 1504 includes one or more configurations (e.g., a suspendConfig) to be applied by the UE. The configurations may include, for example, a configuration related to performing/reporting of early measurements, a configuration related to the suspension/resumption of the connection, and/or a configuration related to redirection to other cells/frequencies.

At block 1506, the UE 300 determines, at the RRC layer, that it is unable to comply with at least one configuration included in the RRCRelease message. In response to this determination, at block 1508, the UE 300 notifies upper layers of the inability to comply with the requested configuration, and triggers a NAS recovery procedure. According to the NAS recovery procedure, the UE 300 sends a RRCSetupRequest message 1510 to the network node 400, which responds with a RRCSetup message 1512. In response, the UE 300 sends a RRCSetupComplete message 1514. The network then identifies, at block 1516, what happened, for example, by identifying that the UE 300 that sent the RRCSetupRequest is the one it tried to release by matching the UE identity, such as the S-TMSI identifier included in the RRCSetupComplete message.

Further embodiments are illustrated in FIG. 15B. As shown therein, in some embodiments, when the UE 300 determines that it is unable to comply with at least one configuration included in the RRCRelease message 1504, the UE 300 triggers a re-establishment procedure at block 1528, according to which the UE 300 sends a RRCReestablishmentRequest message 1530 to the network node 400. In response to the RRCReestablishmentRequest message 1530, the network node 400 identifies, at block 1532, what has happened, for example, by identifying that this UE is the one it tried to release based on the UE identity (PCI+C_RNTI) included in the RRCReestablishmentRequest message 1530. The network node 400 then sends a RRCReestablishment message 1534 to the UE 300, which responds with a RRCReestablishmentComplete message 1536.

Still further embodiments are illustrated in FIG. 15C. As shown therein, the network node 400 decides at block 1540 to keep the UE in a dormant state. When the UE 300 sends a RRCResumeRequest message 1542 to a network node 400, the network node 400 responds with an RRCRelease message 1544 including one or more suspend configurations.

In some embodiments, upon determining an inability to comply with parts of the configuration in RRCRelease the UE does not perform a set of recovery actions, but transitions to the state according to the configuration in the message (e.g. RRC_INACTIVE, if able to comply with the suspendConfig configuration). Then, when the UE initiates a resume procedure (transmits an RRCResumeRequest/RRCResumeRequestl, and receives an RRCResume, it transmits an RRCResumeComplete including an indication, to notify the network of its inability to comply with the previous configuration in RRCRelease.

In summary, concepts herein provide failure handling mechanisms during the reception of a message indicating the wireless device to go to a dormant state (e.g. RRC IDLE with a stored context, RRC_INACTIVE, or RRC_IDLE) where the message can be an RRC release message (e.g. RRCRelease) that may contain configurations (e.g., such suspend configuration, early measurement configuration). Some embodiments trigger recovery actions, so the network is aware the release/suspend procedure transitioning the wireless device state has not succeeded. In addition, the action to trigger failure reporting indicating that the wireless device was not able to apply the configuration within the RRC Release message.

Embodiments described herein may provide advantages including being assured that the wireless device (e.g., user equipments, UE) context that is kept at the network and wireless device will be the same when a wireless device gets suspended to a dormant state, preventing unexpected wireless device behavior. Additionally, it will be possible to identify incorrect/buggy network or wireless device implementation (e.g. if the network is configuring the wireless device beyond its capability, if the wireless device is indicating a capability that it is not able to fulfill). Further, when the wireless device is not able to comply with e.g. an RRCRelease message, the wireless device performs a recovery action to come back to the network so that both can get synchronized in terms of configuration(s) and/or context information they have. Additionally, embodiments may provide consistent behavior of wireless devices in networks employing equipments of different network vendors and consistent behavior of network nodes with wireless devices from different wireless device vendors.

Although embodiments disclosed herein are discussed in terms of NR, such embodiments are equally applicable to LTE.

A method in a wireless device (also referred to as a User Equipment, UE), that has established a radio resource control (RRC) connection with a network node and operating in a CONNECTED state includes receiving an RRC Release like message (e.g. RRCRelease) from the network node, instructing the UE to transition to a dormant sate (e.g. IDLE, IDLE with suspended configuration, INACTIVE), the configuration containing one or more of the following:

a configuration related to performing/reporting of early measurements (i.e. measurements performed in dormant state and reported during transition to a connected state); and /or

a configuration related to the suspension/resumption of the connection (e.g. identities to use when resuming, security configuration to use on resuming, RAN area configuration, etc); and/or

a configurations related to redirection to other cells/frequencies;

The method further includes trying to apply/compile the received configuration in the RRC Release like message, and upon determining that the UE was able to apply/compile the configuration, sending a confirmation message to the network (e.g. RRCReleaseComplete), signifying the UE has properly applied the configuration and transitioning to the IDLE or INACTIVE state, depending on the received configuration (e.g. IDLE state if no suspend configuration was received, INACTIVE state if suspend configuration was received).

Upon determining that the UE was not able to apply/compile the configuration (either partially or fully), the UE may notify the network about the failure.

In some embodiments, this may be done by sending a confirmation message to the network (e.g. RRCReleaseComplete), with an indication (e.g. failure cause) indicating that the UE was not able to apply the configuration. The failure cause can be either a generic cause (e.g. “unable to apply the configuration”) or it can be a detailed cause indicating which part of the configuration the UE was not able to apply (e.g. “unable to apply the early measurement configuration”, “unable to apply the suspend configuration”, etc).

The UE may remain in the CONNECTED state after notifying the network about the failure.

In some embodiments, the UE may notify the network about the failure by triggering a radio link failure like procedure (e.g., executing the procedure for transitioning to an IDLE state with a new release cause “RRC release failure” or initiate the connection re-establishment procedure, and indicate “RRC release failure” in the re-establishment cause)

As in the previous realization, the failure cause can be more detailed. For example, the failure cause can contain elaborate information on what caused the failure.

In some embodiments, if the failure was only partial (e.g. UE was able to apply a suspend configuration but not an early measurement configuration), the UE may notify the failure in the confirmation message (e.g. RRCReleaseComplete), indicating the part that failed (e.g. “early measurement configuration not applied”), but will apply the configuration that was valid and transition to the IDLE/INACTIVE state.

In some embodiments, if the failure was only partial (e.g. UE was able to apply a suspend configuration but not an early measurement configuration), the UE may locally store the failure reason (e.g “early measurement configuration not applied) and apply the configuration that was valid and transition to the IDLE/INACTIVE state (i.e. no failure/confirmation message sent to the network at this point in time).

Upon transitioning to a connected state (e.g. UL data arrival, paging due to DL data arrival, periodic RNA reporting, etc), the UE may send an RRC Resume request-like message (e.g. RRCResumeRequest) indicating the cause for the resumption (e.g. mo-Data to signify mobile originated (UL) data).

If the UE was not able to apply the configuration that was received in the Release message that sent it to the IDLE/INACTIVE state (e.g. UE has saved the failure cause upon the reception of the Release message as discussed in previous bullet), the UE may include an indication that it has not applied that in the resume request message (e.g. “early measurement configuration was not applied”).

In some embodiments, the indication may be sent in a Resume complete-like message (e.g. RRCResumeComplete).

A method in a network node that has established a radio resource control (RRC) connection with a wireless device includes sending an RRC Release-like message (e.g. RRCRelease) from the network node, instructing the UE to transition to a dormant sate (e.g. IDLE, IDLE with suspended configuration, INACTIVE). The message includes a configuration containing one or more of the following: a configuration related to performing/reporting of early measurements (i.e. measurements performed in dormant state and reported during transition to a connected state); and/or a configuration related to the suspension/resumption of the connection (e.g. identities to use when resuming, security configuration to use on resuming, RAN area configuration, etc); and/or a configuration related to redirection to other cells/frequencies.

The network node receives from the wireless device a confirmation message (e.g. RRCReleaseComplete), signifying that the UE has properly applied the full configuration, that the UE has not applied the full configuration, or that the UE has partially applied the configuration.

In case of partial application or not applying the configuration at all, the confirmation message containing a failure cause value(s) (e.g. “unable to apply the early measurement configuration”).

The network node may receive an RRC Resume request-like message (e.g. RRCResumeRequest) from the UE indicating the cause for the resumption (e.g. mo-Data to signify mobile originated (UL) data).

The Resume Request-like message may include an indication that the UE has not applied some or all of the configuration that was received in the previous Release-like message (e.g. “early measurement configuration was not applied”).

The network node may decide to resume the UE's connection by sending a Resume-like message (e.g. RRCResume) to the UE.

The network node may receive a Resume Complete-like message (e.g. RRCResumeComplete) including an indication that the UE has not applied some or all of the configuration that was received in the previous Release like message (e.g. “early measurement configuration was not applied”).

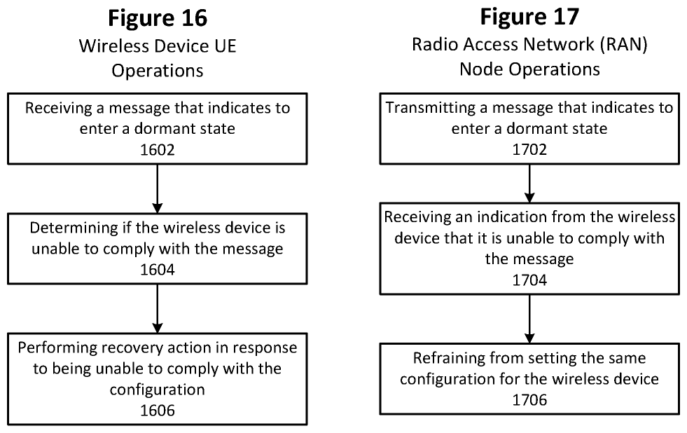

Operations of the wireless device 300 (implemented using the structure of the block diagram of FIG. 3) will now be discussed with reference to the flow chart of FIG. 16 according to some embodiments of inventive concepts. For example, modules may be stored in memory 305 of FIG. 3, and these modules may provide instructions so that when the instructions of a module are executed by respective wireless device processing circuitry 303, processing circuitry 303 performs respective operations of the flow chart.

Reference is now made to FIG. 16, which is a flow chart illustrating operations of a wireless device according to some embodiments herein. Operations include receiving a message that indicates to the wireless device to enter a dormant state, wherein the message comprises at least one configuration (block 1602), determining if the wireless device is unable to comply with the message (block 1604) and, responsive to the wireless device being unable to comply with the configuration included in the message, performing a recovery action (block 1606).

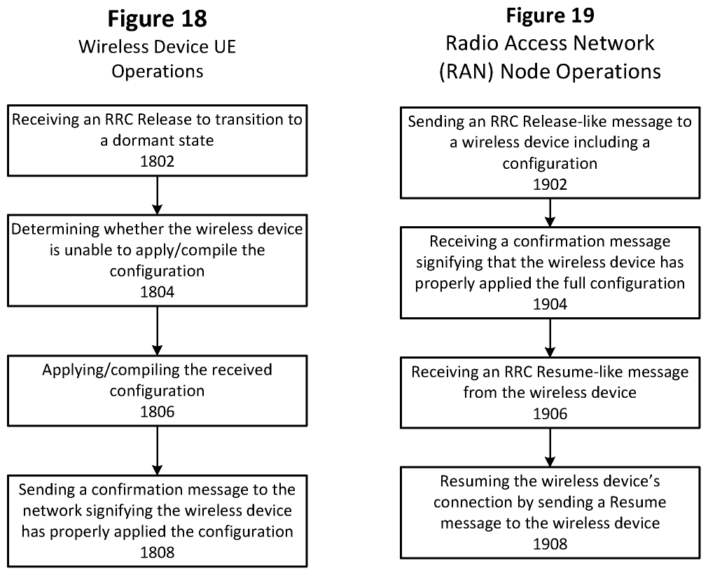

Reference is now made to FIG. 18, which is a flow chart illustrating operations of a wireless device according to some embodiments herein. Operations include receiving an RRC Release like message from a network node, instructing the wireless device to transition to a dormant state (block 1802). In some embodiments, the configuration contains one or more of configurations related to performing/reporting of early measurements, configurations related to the suspension/resumption of the connection, and/or configurations related to redirection to other cells/frequencies. Operations may include trying to apply/compile the received configuration in the RRC Release like message (block 1804) and determining whether the wireless device is able to apply/compile the configuration (block 1806). Operation include sending a confirmation message to the network signifying the wireless device has properly applied the configuration (block 1808).

Operations of a RAN node 400 (implemented using the structure of FIG. 4) will now be discussed with reference to the flow chart of FIG. 17 according to some embodiments of inventive concepts. For example, modules may be stored in memory 405 of FIG. 4, and these modules may provide instructions so that when the instructions of a module are executed by respective RAN node processing circuitry 403, processing circuitry 403 performs respective operations of the flow chart.

Reference is now made to FIG. 17, which is a flow chart illustrating operations of a network node according to some embodiments herein. Operations include transmitting a message that indicates to the UE to enter a dormant state, where the message comprises one or multiple configurations (block 1702), receiving an indication from the UE that it is unable to comply with a message as described above, where being unable to comply with a message comprises not complying with part of the configuration included in the message (block 1704), and refraining from setting the same configuration if it wants to suspend or release that UE again (block 1706).

Operations of a Core Network CN node 500 (implemented using the structure of FIG. 5) will now be discussed with reference to the flow chart of FIG. 19 according to some embodiments of inventive concepts. For example, modules may be stored in memory 505 of FIG. 5, and these modules may provide instructions so that when the instructions of a module are executed by respective CN node processing circuitry 503, processing circuitry 503 performs respective operations of the flow chart.

Reference is now made to FIG. 19, which is a flow chart illustrating operations of a network node according to some embodiments herein. Operations include sending an RRC Release like message from the network node, instructing the wireless device to transition to a dormant state (block 1902), receiving from the wireless device a confirmation message signifying that the wireless device has properly applied the full configuration, the wireless device has not applied the full configuration, or the wireless device has partially applied the configuration (block 1904), receiving an RRC Resume request like message from the wireless device indicating the cause for the resumption (block 1906), and deciding to resume the wireless device's connection by sending a Resume message to the wireless device (block 1908).

### Embodiments of the Disclosure

Embodiment 1. A method of operating a wireless device in a communication network, comprising for handling the inability to comply with a configuration, the method comprising:
receiving a message that indicates to the wireless device to enter a dormant state, wherein the message comprises at least one configuration;

determining if the wireless device is unable to comply with the message; and
responsive to the wireless device being unable to comply with the configuration included in the message, performing a recovery action.

Embodiment 2. The method of embodiment 1, wherein the message comprises a RRCRelease message.

Embodiment 3. The method of embodiment 1, wherein the message comprises a RRCConnectionRelease message.

Embodiment 4. The method of any of embodiments 1-3, wherein the configuration refers to a field that is associated with an information element that may be included in the message.

Embodiment 5. The method of embodiment 4, wherein the field comprises at least one of: redirectedCarrierInfo of IE RedirectedCarrierinfo; cellReselectionPriorities of IE CellReselectionPriorities; suspendConfig of IE SuspendConfig; deprioritisationReq of IE SEQUENCE {deprioritisationType ENUMERATED {frequency, nr}, deprioritisationTimer of IE ENUMERATED {min5, min10, min15, min30} }; measIdleConfig of IE MeasldleConfigDedicated; and/or any other configuration received in the Release message.

Embodiment 6. The method of any of embodiments 1-5, wherein the dormant state comprises: RRC_INACTIVE; RRC_IDLE; RRC_IDLE with a stored context, any other state designed mainly for power savings at the UE; and /or any other state where the UE performs cell reselection.

Embodiment 7. The method of any of embodiments 1-6, wherein determining that the wireless device is unable to comply with the message comprises determining that the wireless device is unable to comply with a portion of the configuration included in the message.

Embodiment 8. The method of any of embodiments 1-7, wherein the message comprises a plurality of configurations that comprise respective fields and information elements, and wherein determining that the wireless device is unable to comply with the message comprises determining that the wireless device is unable to comply with one of the fields and/or information elements.

Embodiment 9. The method of any of embodiments 1-8, wherein the recovery action comprises at least one of: performing actions upon going to RRC_IDLE; determining a release cause associated to a failure that is indicated to upper layers; responsive to a failure indication as release cause, triggering , by the upper layers, a recovery procedure in which the wireless device enters IDLE and attempts to enter CONNECTED via an RRC Connection Establishment; and initiating the connection re-establishment procedure.

Embodiment 10. The method of embodiments 9, wherein the failure comprises at least one of a suspend failure; a release failure; a resume failure; and a reconfiguration failure.

Embodiment 11. The method of any of embodiments 1-10, wherein receiving the message is performed while the wireless device is in RRC_CONNECTED, and wherein performing the recovery action is based on determining if the AS security has been activated.

Embodiment 12. The method of embodiment 11, wherein responsive to determining that the AS security has not been activated, the recovery action is performed upon going to RRC_IDLE.

Embodiment 13. The method of embodiment 11, wherein responsive to determining that the AS security has been activated and that SRB2 and at least one DRB have not been setup, the recovery action is performed upon going to RRC IDLE with release cause indicating a failure.

Embodiment 14. The method embodiment 13, wherein the failure comprises one or more of a suspend failure, a release failure, a resume failure, and a reconfiguration failure that is indicated to upper layers.

Embodiment 15. The method of embodiment 11, further comprising initiating the connection re-establishment procedure, upon which the reconfiguration procedure ends.

Embodiment 16. The method of any of embodiments 1-10, wherein receiving the message is performed while the wireless device is in RRC_INACTIVE, wherein the wireless device is performing the recovery action, and wherein operations further comprise initiating the connection re-establishment procedure, upon which the reconfiguration procedure ends.

Embodiment 17. The method of any of embodiments 1-10, wherein the message causes a protocol error that corresponds to a generic error handling that specifies that the wireless device ignore the message

Embodiment 18. The method of any of embodiments 1-10, wherein responsive to the wireless device being unable to comply with any part of the configuration, the wireless device does not apply any of the configuration.

Embodiment 19. The method of any of embodiments 1-10, wherein, responsive to the wireless device being unable to comply with a portion of the configuration, further applying a portion of the configuration that the wireless device can comply with and logging an indication regarding which portion of the configuration that the wireless device can not comply with.

Embodiment 20. The method of embodiment 19, further comprising causing a message to be sent to the communication network that includes an identity of the portion of the configuration that the wireless device can not comply during and/or after a recovery operation.

Embodiment 21. A method of operating a wireless network node (eNB, eNodeB, gNodeB, gNB), the method comprising:
transmitting a message that indicates to the UE to enter a dormant state, where the message comprises one or multiple configurations;
receiving an indication from the UE that it is unable to comply with a message as described above, where being unable to comply with a message comprises not complying with part of the configuration included in the message; and
refraining from setting the same configuration if it wants to suspend or release that UE again.

Embodiment 22. A method of operating a wireless device that has established a radio resource control (RRC) connection with a network node in a communication network and operating in a CONNECTED state, comprising:
receiving an RRC Release like message from the network node, instructing the wireless device to transition to a dormant state, the configuration containing one or more of:
   configurations related to performing/reporting of early measurements; configurations related to the suspension/resumption of the connection; and/or configurations related to redirection to other cells/frequencies.

Embodiment 23. The method of embodiment 22, further comprising trying to apply/compile the received configuration in the RRC Release like message.

Embodiment 24. The method of embodiment 23, further comprising determining whether the wireless device is able to apply/compile the configuration.

Embodiment 25. The method of embodiment 24, further comprising responsive to determining that the wireless device was able to apply/compile the configuration, sending a confirmation message to the network signifying the wireless device has properly applied the configuration and transitioning to the IDLE or INACTIVE state, depending on the received configuration.

Embodiment 26. The method of embodiment 25, further comprising responsive to determining that the wireless device was not able to apply/compile the configuration (either partially or fully), notifying the network about the failure.

Embodiment 27. The method of embodiment 26, wherein notifying the network about the failure comprises sending a confirmation message to the network with an indication of a failure cause indicating that the UE was not able to apply the configuration.

Embodiment 28. The method of embodiment 27, wherein the failure cause comprises a generic cause or a detailed cause indicating which part of the configuration the wireless device was not able to apply.

Embodiment 29. The method of embodiment 28, wherein the wireless device stays in the CONNECTED state.

Embodiment 30. The method of embodiment 26, wherein notifying the network about the failure comprises triggering a radio link failure type procedure .

Embodiment 31. The method of embodiment 26, wherein the failure cause comprises a detail containing elaborate information on what caused the failure.

Embodiment 32. The method of embodiment 26, wherein, if the failure was only partial, the wireless device notifies the failure in the confirmation message indicating the part that failed.

Embodiment 33. The method of embodiment 32, wherein the wireless device applies the configuration that was valid and transitions to the IDLE/INACTIVE state.

Embodiment 34. The method of embodiment 32, wherein the wireless device locally stores the failure reason, applies the configuration that was valid and transitions to the IDLE/INACTIVE state.

Embodiment 35. The method of any of embodiments 22-34, further comprising, upon transitioning to a connected state, sending an RRC Resume request like message indicating the cause for the resumption.

Embodiment 36. The method of any of embodiments 22-35, responsive to the wireless device not being able to apply the configuration that was received in the release message that sent it to the IDLE/INACTIVE state, the wireless device includes an indication that it has not applied that in the resume request message.

Embodiment 37. The method of embodiment 36, wherein the indication is sent in a Resume complete type message.

Embodiment 38. A method of operating a wireless network node (eNB, eNodeB, gNodeB, gNB), that has established a radio resource control (RRC) connection with a wireless device, the method comprising:
sending an RRC Release like message from the network node, instructing the wireless device to transition to a dormant state;
receiving from the wireless device a confirmation message signifying that the wireless device has properly applied the full configuration, the wireless device has not applied the full configuration, or the wireless device has partially applied the configuration;
receiving an RRC Resume request like message from the wireless device indicating the cause for the resumption; and
deciding to resume the wireless device's connection by sending a Resume message to the wireless device.

Embodiment 39. A method of embodiment 38, wherein the configuration comprises one or more of configurations related to performing/reporting of early measurements; configurations related to the suspension/resumption of the connection; and/or configurations related to redirection to other cells/frequencies.

Embodiment 40. The method of any of embodiments 38-39, wherein in case of partial application or not applying the configuration at all, a confirmation message comprise a failure cause value.

Embodiment 41. The method of any of embodiments 38-40, wherein the RRC Resume request like message comprises an indication that the wireless device has not applied some or all of the configuration that was received in the previous Release like message.

Embodiment 42. The method of any of embodiments 38-41, wherein deciding to resume the wireless device's connection by sending a Resume like message to the wireless device comprises receiving a Resume Complete like message that includes an indication that the wireless device has not applied some or all of the configuration that was received in the previous Release like message.

Embodiment 43. A wireless device (300) comprising:
processing circuitry (303); and
memory (305) coupled with the processing circuitry, wherein the memory includes instructions that when executed by the processing circuitry causes the wireless device to perform operations according to any of Embodiments 1-20.

Embodiment 44. A wireless device (300) adapted to perform according to any of Embodiments 1-20.

Embodiment 45. A computer program comprising program code to be executed by processing circuitry (303) of a wireless device (300), whereby execution of the program code causes the wireless device (300) to perform operations according to any of embodiments 1-20.

Embodiment 46. A computer program product comprising a non-transitory storage medium including program code to be executed by processing circuitry (303) of a wireless device (300), whereby execution of the program code causes the wireless device (300) to perform operations according to any of embodiments 1-20.

Embodiment 47. A method of operating a radio access network node, RAN, in a communication network, the method comprising:
transmitting a message that indicates to the UE to enter a dormant state, where the message comprises one or multiple configurations;
receiving an indication from the UE that it is unable to comply with a message as described above, where being unable to comply with a message comprises not complying with (part of) the configuration included in the message; and
refraining from setting the same configuration if it wants to suspend or release that UE again

Embodiment 48. A radio access network, RAN, node (400) comprising:
processing circuitry (403); and
memory (405) coupled with the processing circuitry, wherein the memory includes instructions that when executed by the processing circuitry causes the RAN node to perform operations according to any of Embodiments 38-42.

Embodiment 49. A radio access network, RAN, node (400) adapted to perform according to any of Embodiments 38-42.

Embodiment 50. A computer program comprising program code to be executed by processing circuitry (403) of a radio access network, RAN, node (400), whereby execution of the program code causes the RAN node (400) to perform operations according to any of embodiments 38-42.

Embodiment 51. A computer program product comprising a non-transitory storage medium including program code to be executed by processing circuitry (403) of a radio access network, RAN, node (400), whereby execution of the program code causes the RAN node (400) to perform operations according to any of embodiments 38-42.

Embodiment 52. A method of operating a core network, CN, node (500) configured to operate in a communication network, the method comprising:
transmitting a message that indicates to the UE to enter a dormant state, where the message comprises one or multiple configurations;
receiving an indication from the UE that it is unable to comply with a message as described above, where being unable to comply with a message comprises not complying with part of the configuration included in the message; and
refraining from setting the same configuration if it wants to suspend or release that UE again.

Embodiment 53. A method of operating a core network, CN, node (500) configured to operate in a communication network, the method comprising:
sending an RRC Release like message from the network node, instructing the wireless device to transition to a dormant state;
receiving from the wireless device a confirmation message signifying that the wireless device has properly applied the full configuration, the wireless device has not applied the full configuration, or the wireless device has partially applied the configuration;
receiving an RRC Resume request like message from the wireless device indicating the cause for the resumption; and
deciding to resume the wireless device's connection by sending a Resume message to the wireless device.

Embodiment 54. A core network, CN, node (500) comprising:
processing circuitry (503); and
memory (505) coupled with the processing circuitry, wherein the memory includes instructions that when executed by the processing circuitry causes the CN node to perform operations according to any of Embodiments 38-42.

Embodiment 55. A core network, CN, node (500) adapted to perform according to any of Embodiments 38-42.

Embodiment 56. A computer program comprising program code to be executed by processing circuitry (403) of a core network, CN, node (500), whereby execution of the program code causes the CN node (500) to perform operations according to any of embodiments 38-42.

Embodiment 57. A computer program product comprising a non-transitory storage medium including program code to be executed by processing circuitry (503) of a core network, CN, node (500), whereby execution of the program code causes the CN node (500) to perform operations according to any of embodiments 38-42.

Embodiment 58. A wireless device (300) comprising:
processing circuitry (303); and
memory (305) coupled with the processing circuitry, wherein the memory includes instructions that when executed by the processing circuitry causes the wireless device to perform operations according to any of Embodiments 23-37.

Embodiment 59. A wireless device (300) adapted to perform according to any of Embodiments 23-37.

Embodiment 60. A computer program comprising program code to be executed by processing circuitry (303) of a wireless device (300), whereby execution of the program code causes the wireless device (300) to perform operations according to any of embodiments 23-37.

Embodiment 61. A computer program product comprising a non-transitory storage medium including program code to be executed by processing circuitry (303) of a wireless device (300), whereby execution of the program code causes the wireless device (300) to perform operations according to any of embodiments 23-37.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 20 1 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 20. For simplicity, the wireless network of FIG. 20 only depicts network 2006, network nodes 2060 and 2060b, and WDs 2010, 2010b, and 2010c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 2060 and wireless device (WD) 2010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 2006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 2060 and WD 2010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 20, network node 2060 includes processing circuitry 2070, device readable medium 2080, interface 2090, auxiliary equipment 2084, power source 2086, power circuitry 2087, and antenna 2062. Although network node 2060 illustrated in the example wireless network of FIG. 201 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 2060 are depicted as single boxes located within a larger box, or nested within multiple boxes, in practice, a network node may comprise multiple different physical components that make up a single illustrated component (e.g., device readable medium 2080 may comprise multiple separate hard drives as well as multiple RAM modules).

Similarly, network node 2060 may be composed of multiple physically separate components (e.g., a NodeB component and a RNC component, or a BTS component and a BSC component, etc.), which may each have their own respective components. In certain scenarios in which network node 2060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 2060 may be configured to support multiple radio access technologies (RATs). In such embodiments, some components may be duplicated (e.g., separate device readable medium 2080 for the different RATs) and some components may be reused (e.g., the same antenna 2062 may be shared by the RATs). Network node 2060 may also include multiple sets of the various illustrated components for different wireless technologies integrated into network node 2060, such as, for example, GSM, WCDMA, LTE, NR, WiFi, or Bluetooth wireless technologies. These wireless technologies may be integrated into the same or different chip or set of chips and other components within network node 2060.

Processing circuitry 2070 is configured to perform any determining, calculating, or similar operations (e.g., certain obtaining operations) described herein as being provided by a network node. These operations performed by processing circuitry 2070 may include processing information obtained by processing circuitry 2070 by, for example, converting the obtained information into other information, comparing the obtained information or converted information to information stored in the network node, and/or performing one or more operations based on the obtained information or converted information, and as a result of said processing making a determination.

Processing circuitry 2070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2060 components, such as device readable medium 2080, network node 2060 functionality. For example, processing circuitry 2070 may execute instructions stored in device readable medium 2080 or in memory within processing circuitry 2070. Such functionality may include providing any of the various wireless features, functions, or benefits discussed herein. In some embodiments, processing circuitry 2070 may include a system on a chip (SOC).

In some embodiments, processing circuitry 2070 may include one or more of radio frequency (RF) transceiver circuitry 2072 and baseband processing circuitry 2074. In some embodiments, radio frequency (RF) transceiver circuitry 2072 and baseband processing circuitry 2074 may be on separate chips (or sets of chips), boards, or units, such as radio units and digital units. In alternative embodiments, part or all of RF transceiver circuitry 2072 and baseband processing circuitry 2074 may be on the same chip or set of chips, boards, or units

In certain embodiments, some or all of the functionality described herein as being provided by a network node, base station, eNB or other such network device may be performed by processing circuitry 2070 executing instructions stored on device readable medium 2080 or memory within processing circuitry 2070. In alternative embodiments, some or all of the functionality may be provided by processing circuitry 2070 without executing instructions stored on a separate or discrete device readable medium, such as in a hard-wired manner. In any of those embodiments, whether executing instructions stored on a device readable storage medium or not, processing circuitry 2070 can be configured to perform the described functionality. The benefits provided by such functionality are not limited to processing circuitry 2070 alone or to other components of network node 2060, but are enjoyed by network node 2060 as a whole, and/or by end users and the wireless network generally.

Device readable medium 2080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 2070. Device readable medium 2080 may store any suitable instructions, data or information, including a computer program, software, an application including one or more of logic, rules, code, tables, etc. and/or other instructions capable of being executed by processing circuitry 2070 and, utilized by network node 2060. Device readable medium 2080 may be used to store any calculations made by processing circuitry 2070 and/or any data received via interface 2090. In some embodiments, processing circuitry 2070 and device readable medium 2080 may be considered to be integrated.

Interface 2090 is used in the wired or wireless communication of signalling and/or data between network node 2060, network 2006, and/or WDs 2010. As illustrated, interface 2090 comprises port(s)/terminal(s) 2094 to send and receive data, for example to and from network 2006 over a wired connection. Interface 2090 also includes radio front end circuitry 2092 that may be coupled to, or in certain embodiments a part of, antenna 2062. Radio front end circuitry 2092 comprises filters 2098 and amplifiers 2096. Radio front end circuitry 2092 may be connected to antenna 2062 and processing circuitry 2070. Radio front end circuitry may be configured to condition signals communicated between antenna 2062 and processing circuitry 2070. Radio front end circuitry 2092 may receive digital data that is to be sent out to other network nodes or WDs via a wireless connection. Radio front end circuitry 2092 may convert the digital data into a radio signal having the appropriate channel and bandwidth parameters using a combination of filters 2098 and/or amplifiers 2096. The radio signal may then be transmitted via antenna 2062. Similarly, when receiving data, antenna 2062 may collect radio signals which are then converted into digital data by radio front end circuitry 2092. The digital data may be passed to processing circuitry 2070. In other embodiments, the interface may comprise different components and/or different combinations of components.

In certain alternative embodiments, network node 2060 may not include separate radio front end circuitry 2092, instead, processing circuitry 2070 may comprise radio front end circuitry and may be connected to antenna 2062 without separate radio front end circuitry 2092. Similarly, in some embodiments, all or some of RF transceiver circuitry 2072 may be considered a part of interface 2090. In still other embodiments, interface 2090 may include one or more ports or terminals 2094, radio front end circuitry 2092, and RF transceiver circuitry 2072, as part of a radio unit (not shown), and interface 2090 may communicate with baseband processing circuitry 2074, which is part of a digital unit (not shown).

Antenna 2062 may include one or more antennas, or antenna arrays, configured to send and/or receive wireless signals. Antenna 2062 may be coupled to radio front end circuitry 2090 and may be any type of antenna capable of transmitting and receiving data and/or signals wirelessly. In some embodiments, antenna 2062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 2062 may be separate from network node 2060 and may be connectable to network node 2060 through an interface or port.

Antenna 2062, interface 2090, and/or processing circuitry 2070 may be configured to perform any receiving operations and/or certain obtaining operations described herein as being performed by a network node. Any information, data and/or signals may be received from a wireless device, another network node and/or any other network equipment. Similarly, antenna 2062, interface 2090, and/or processing circuitry 2070 may be configured to perform any transmitting operations described herein as being performed by a network node. Any information, data and/or signals may be transmitted to a wireless device, another network node and/or any other network equipment.

Power circuitry 2087 may comprise, or be coupled to, power management circuitry and is configured to supply the components of network node 2060 with power for performing the functionality described herein. Power circuitry 2087 may receive power from power source 2086. Power source 2086 and/or power circuitry 2087 may be configured to provide power to the various components of network node 2060 in a form suitable for the respective components (e.g., at a voltage and current level needed for each respective component). Power source 2086 may either be included in, or external to, power circuitry 2087 and/or network node 2060. For example, network node 2060 may be connectable to an external power source (e.g., an electricity outlet) via an input circuitry or interface such as an electrical cable, whereby the external power source supplies power to power circuitry 2087. As a further example, power source 2086 may comprise a source of power in the form of a battery or battery pack which is connected to, or integrated in, power circuitry 2087. The battery may provide backup power should the external power source fail. Other types of power sources, such as photovoltaic devices, may also be used.

Alternative embodiments of network node 2060 may include additional components beyond those shown in FIG. 20 that may be responsible for providing certain aspects of the network node's functionality, including any of the functionality described herein and/or any functionality necessary to support the subject matter described herein. For example, network node 2060 may include user interface equipment to allow input of information into network node 2060 and to allow output of information from network node 2060. This may allow a user to perform diagnostic, maintenance, repair, and other administrative functions for network node 2060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 2010 includes antenna 2011, interface 2014, processing circuitry 2020, device readable medium 2030, user interface equipment 2032, auxiliary equipment 2034, power source 2036 and power circuitry 2037. WD 2010 may include multiple sets of one or more of the illustrated components for different wireless technologies supported by WD 2010, such as, for example, GSM, WCDMA, LTE, NR, WiFi, WiMAX, or Bluetooth wireless technologies, just to mention a few. These wireless technologies may be integrated into the same or different chips or set of chips as other components within WD 2010.

Antenna 2011 may include one or more antennas or antenna arrays, configured to send and/or receive wireless signals, and is connected to interface 2014. In certain alternative embodiments, antenna 2011 may be separate from WD 2010 and be connectable to WD 2010 through an interface or port. Antenna 2011, interface 2014, and/or processing circuitry 2020 may be configured to perform any receiving or transmitting operations described herein as being performed by a WD. Any information, data and/or signals may be received from a network node and/or another WD. In some embodiments, radio front end circuitry and/or antenna 2011 may be considered an interface.

As illustrated, interface 2014 comprises radio front end circuitry 2012 and antenna 2011. Radio front end circuitry 2012 comprise one or more filters 2018 and amplifiers 2016. Radio front end circuitry 2014 is connected to antenna 2011 and processing circuitry 2020, and is configured to condition signals communicated between antenna 2011 and processing circuitry 2020. Radio front end circuitry 2012 may be coupled to or a part of antenna 2011. In some embodiments, WD 2010 may not include separate radio front end circuitry 2012; rather, processing circuitry 2020 may comprise radio front end circuitry and may be connected to antenna 2011. Similarly, in some embodiments, some or all of RF transceiver circuitry 2022 may be considered a part of interface 2014. Radio front end circuitry 2012 may receive digital data that is to be sent out to other network nodes or WDs via a wireless connection. Radio front end circuitry 2012 may convert the digital data into a radio signal having the appropriate channel and bandwidth parameters using a combination of filters 2018 and/or amplifiers 2016. The radio signal may then be transmitted via antenna 2011. Similarly, when receiving data, antenna 2011 may collect radio signals which are then converted into digital data by radio front end circuitry 2012. The digital data may be passed to processing circuitry 2020. In other embodiments, the interface may comprise different components and/or different combinations of components.

Processing circuitry 2020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 2010 components, such as device readable medium 2030, WD 2010 functionality. Such functionality may include providing any of the various wireless features or benefits discussed herein. For example, processing circuitry 2020 may execute instructions stored in device readable medium 2030 or in memory within processing circuitry 2020 to provide the functionality disclosed herein.

As illustrated, processing circuitry 2020 includes one or more of RF transceiver circuitry 2022, baseband processing circuitry 2024, and application processing circuitry 2026. In other embodiments, the processing circuitry may comprise different components and/or different combinations of components. In certain embodiments processing circuitry 2020 of WD 2010 may comprise a SOC. In some embodiments, RF transceiver circuitry 2022, baseband processing circuitry 2024, and application processing circuitry 2026 may be on separate chips or sets of chips. In alternative embodiments, part or all of baseband processing circuitry 2024 and application processing circuitry 2026 may be combined into one chip or set of chips, and RF transceiver circuitry 2022 may be on a separate chip or set of chips. In still alternative embodiments, part or all of RF transceiver circuitry 2022 and baseband processing circuitry 2024 may be on the same chip or set of chips, and application processing circuitry 2026 may be on a separate chip or set of chips. In yet other alternative embodiments, part or all of RF transceiver circuitry 2022, baseband processing circuitry 2024, and application processing circuitry 2026 may be combined in the same chip or set of chips. In some embodiments, RF transceiver circuitry 2022 may be a part of interface 2014. RF transceiver circuitry 2022 may condition RF signals for processing circuitry 2020.

In certain embodiments, some or all of the functionality described herein as being performed by a WD may be provided by processing circuitry 2020 executing instructions stored on device readable medium 2030, which in certain embodiments may be a computer-readable storage medium. In alternative embodiments, some or all of the functionality may be provided by processing circuitry 2020 without executing instructions stored on a separate or discrete device readable storage medium, such as in a hard-wired manner. In any of those particular embodiments, whether executing instructions stored on a device readable storage medium or not, processing circuitry 2020 can be configured to perform the described functionality. The benefits provided by such functionality are not limited to processing circuitry 2020 alone or to other components of WD 2010, but are enjoyed by WD 2010 as a whole, and/or by end users and the wireless network generally.

Processing circuitry 2020 may be configured to perform any determining, calculating, or similar operations (e.g., certain obtaining operations) described herein as being performed by a WD. These operations, as performed by processing circuitry 2020, may include processing information obtained by processing circuitry 2020 by, for example, converting the obtained information into other information, comparing the obtained information or converted information to information stored by WD 2010, and/or performing one or more operations based on the obtained information or converted information, and as a result of said processing making a determination.

Device readable medium 2030 may be operable to store a computer program, software, an application including one or more of logic, rules, code, tables, etc. and/or other instructions capable of being executed by processing circuitry 2020. Device readable medium 2030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 2020. In some embodiments, processing circuitry 2020 and device readable medium 2030 may be considered to be integrated.

User interface equipment 2032 may provide components that allow for a human user to interact with WD 2010. Such interaction may be of many forms, such as visual, audial, tactile, etc. User interface equipment 2032 may be operable to produce output to the user and to allow the user to provide input to WD 2010. The type of interaction may vary depending on the type of user interface equipment 2032 installed in WD 2010. For example, if WD 2010 is a smart phone, the interaction may be via a touch screen; if WD 2010 is a smart meter, the interaction may be through a screen that provides usage (e.g., the number of gallons used) or a speaker that provides an audible alert (e.g., if smoke is detected). User interface equipment 2032 may include input interfaces, devices and circuits, and output interfaces, devices and circuits. User interface equipment 2032 is configured to allow input of information into WD 2010, and is connected to processing circuitry 2020 to allow processing circuitry 2020 to process the input information. User interface equipment 2032 may include, for example, a microphone, a proximity or other sensor, keys/buttons, a touch display, one or more cameras, a USB port, or other input circuitry. User interface equipment 2032 is also configured to allow output of information from WD 2010, and to allow processing circuitry 2020 to output information from WD 2010. User interface equipment 2032 may include, for example, a speaker, a display, vibrating circuitry, a USB port, a headphone interface, or other output circuitry. Using one or more input and output interfaces, devices, and circuits, of user interface equipment 2032, WD 2010 may communicate with end users and/or the wireless network, and allow them to benefit from the functionality described herein.

Auxiliary equipment 2034 is operable to provide more specific functionality which may not be generally performed by WDs. This may comprise specialized sensors for doing measurements for various purposes, interfaces for additional types of communication such as wired communications etc. The inclusion and type of components of auxiliary equipment 2034 may vary depending on the embodiment and/or scenario.

Power source 2036 may, in some embodiments, be in the form of a battery or battery pack. Other types of power sources, such as an external power source (e.g., an electricity outlet), photovoltaic devices or power cells, may also be used. WD 2010 may further comprise power circuitry 2037 for delivering power from power source 2036 to the various parts of WD 2010 which need power from power source 2036 to carry out any functionality described or indicated herein. Power circuitry 2037 may in certain embodiments comprise power management circuitry. Power circuitry 2037 may additionally or alternatively be operable to receive power from an external power source; in which case WD 2010 may be connectable to the external power source (such as an electricity outlet) via input circuitry or an interface such as an electrical power cable. Power circuitry 2037 may also in certain embodiments be operable to deliver power from an external power source to power source 2036. This may be, for example, for the charging of power source 2036. Power circuitry 2037 may perform any formatting, converting, or other modification to the power from power source 2036 to make the power suitable for the respective components of WD 2010 to which power is supplied.

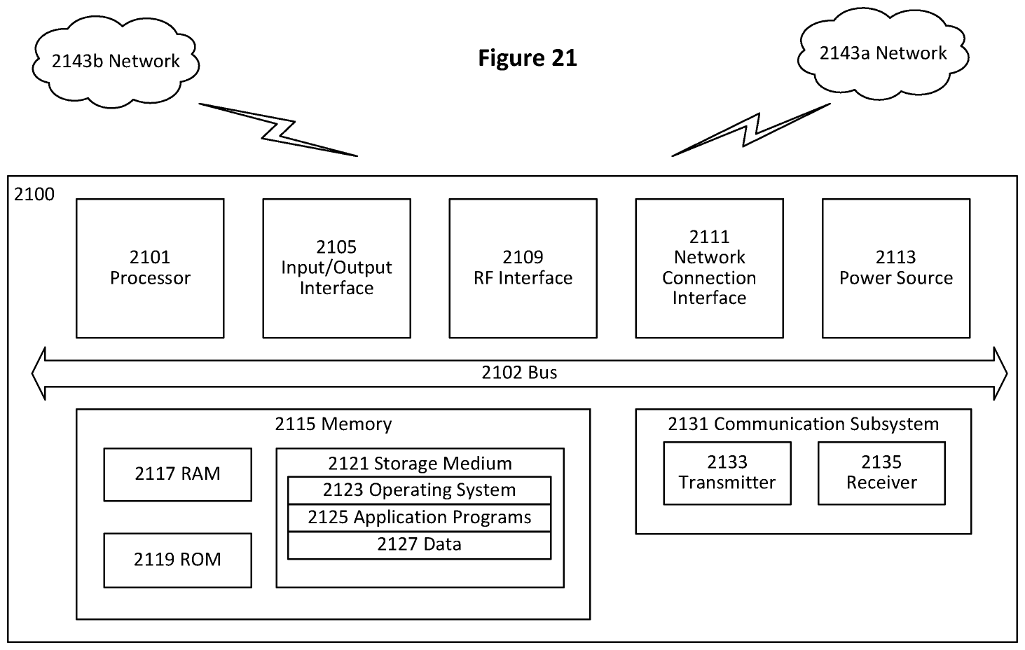

FIG. 21 illustrates a user Equipment in accordance with some embodiments.

FIG. 21 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 21200 may be any UE identified by the 3rd Generation Partnership Project (3GPP), including a NB-IoT UE, a machine type communication (MTC) UE, and/or an enhanced MTC (eMTC) UE. UE 2100, as illustrated in FIG. 21, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 21 is a UE, the components discussed herein are equally applicable to a WD, and vice-versa.

In FIG. 21, UE 2100 includes processing circuitry 2101 that is operatively coupled to input/output interface 2105, radio frequency (RF) interface 2109, network connection interface 2111, memory 2115 including random access memory (RAM) 2117, read-only memory (ROM) 2119, and storage medium 2121 or the like, communication subsystem 2131, power source 2133, and/or any other component, or any combination thereof. Storage medium 2121 includes operating system 2123, application program 2125, and data 2127. In other embodiments, storage medium 2121 may include other similar types of information. Certain UEs may utilize all of the components shown in FIG. 21, or only a subset of the components. The level of integration between the components may vary from one UE to another UE. Further, certain UEs may contain multiple instances of a component, such as multiple processors, memories, transceivers, transmitters, receivers, etc.

In FIG. 21, processing circuitry 2101 may be configured to process computer instructions and data. Processing circuitry 2101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 2101 may include two central processing units (CPUs). Data may be information in a form suitable for use by a computer.

In the depicted embodiment, input/output interface 2105 may be configured to provide a communication interface to an input device, output device, or input and output device. UE 2100 may be configured to use an output device via input/output interface 2105. An output device may use the same type of interface port as an input device. For example, a USB port may be used to provide input to and output from UE 2100. The output device may be a speaker, a sound card, a video card, a display, a monitor, a printer, an actuator, an emitter, a smartcard, another output device, or any combination thereof. UE 2100 may be configured to use an input device via input/output interface 2105 to allow a user to capture information into UE 2100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 21, RF interface 2109 may be configured to provide a communication interface to RF components such as a transmitter, a receiver, and an antenna. Network connection interface 2111 may be configured to provide a communication interface to network 2143a. Network 2143a may encompass wired and/or wireless networks such as a local-area network (LAN), a wide-area network (WAN), a computer network, a wireless network, a telecommunications network, another like network or any combination thereof. For example, network 2143a may comprise a Wi-Fi network. Network connection interface 2111 may be configured to include a receiver and a transmitter interface used to communicate with one or more other devices over a communication network according to one or more communication protocols, such as Ethernet, TCP/IP, SONET, ATM, or the like. Network connection interface 2111 may implement receiver and transmitter functionality appropriate to the communication network links (e.g., optical, electrical, and the like). The transmitter and receiver functions may share circuit components, software or firmware, or alternatively may be implemented separately.

RAM 2117 may be configured to interface via bus 2102 to processing circuitry 2101 to provide storage or caching of data or computer instructions during the execution of software programs such as the operating system, application programs, and device drivers. ROM 2119 may be configured to provide computer instructions or data to processing circuitry 2101. For example, ROM 2119 may be configured to store invariant low-level system code or data for basic system functions such as basic input and output (I/O), startup, or reception of keystrokes from a keyboard that are stored in a non-volatile memory. Storage medium 2121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 2121 may be configured to include operating system 2123, application program 2125 such as a web browser application, a widget or gadget engine or another application, and data file 2127. Storage medium 2121 may store, for use by UE 2100, any of a variety of various operating systems or combinations of operating systems.

Storage medium 2121 may be configured to include a number of physical drive units, such as redundant array of independent disks (RAID), floppy disk drive, flash memory, USB flash drive, external hard disk drive, thumb drive, pen drive, key drive, high-density digital versatile disc (1-1D-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 2121 may allow UE 2100 to access computer-executable instructions, application programs or the like, stored on transitory or non-transitory memory media, to off-load data, or to upload data. An article of manufacture, such as one utilizing a communication system may be tangibly embodied in storage medium 2121, which may comprise a device readable medium.

In FIG. 21, processing circuitry 2101 may be configured to communicate with network 2143b using communication subsystem 2131. Network 2143a and network 2143b may be the same network or networks or different network or networks. Communication subsystem 2131 may be configured to include one or more transceivers used to communicate with network 2143b. For example, communication subsystem 2131 may be configured to include one or more transceivers used to communicate with one or more remote transceivers of another device capable of wireless communication such as another WD, UE, or base station of a radio access network (RAN) according to one or more communication protocols, such as IEEE 802.21, CDMA, WCDMA, GSM, LTE, UTRAN, WiMax, or the like. Each transceiver may include transmitter 2133 and/or receiver 2135 to implement transmitter or receiver functionality, respectively, appropriate to the RAN links (e.g., frequency allocations and the like). Further, transmitter 2133 and receiver 2135 of each transceiver may share circuit components, software or firmware, or alternatively may be implemented separately.

In the illustrated embodiment, the communication functions of communication subsystem 2131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 2131 may include cellular communication, Wi-Fi communication, Bluetooth communication, and GPS communication. Network 2143b may encompass wired and/or wireless networks such as a local-area network (LAN), a wide-area network (WAN), a computer network, a wireless network, a telecommunications network, another like network or any combination thereof. For example, network 2143b may be a cellular network, a Wi-Fi network, and/or a near-field network. Power source 2113 may be configured to provide alternating current (AC) or direct current (DC) power to components of UE 2100.

The features, benefits and/or functions described herein may be implemented in one of the components of UE 2100 or partitioned across multiple components of UE 2100. Further, the features, benefits, and/or functions described herein may be implemented in any combination of hardware, software or firmware. In one example, communication subsystem 2131 may be configured to include any of the components described herein. Further, processing circuitry 2101 may be configured to communicate with any of such components over bus 2102. In another example, any of such components may be represented by program instructions stored in memory that when executed by processing circuitry 2101 perform the corresponding functions described herein. In another example, the functionality of any of such components may be partitioned between processing circuitry 2101 and communication subsystem 2131. In another example, the non-computationally intensive functions of any of such components may be implemented in software or firmware and the computationally intensive functions may be implemented in hardware.

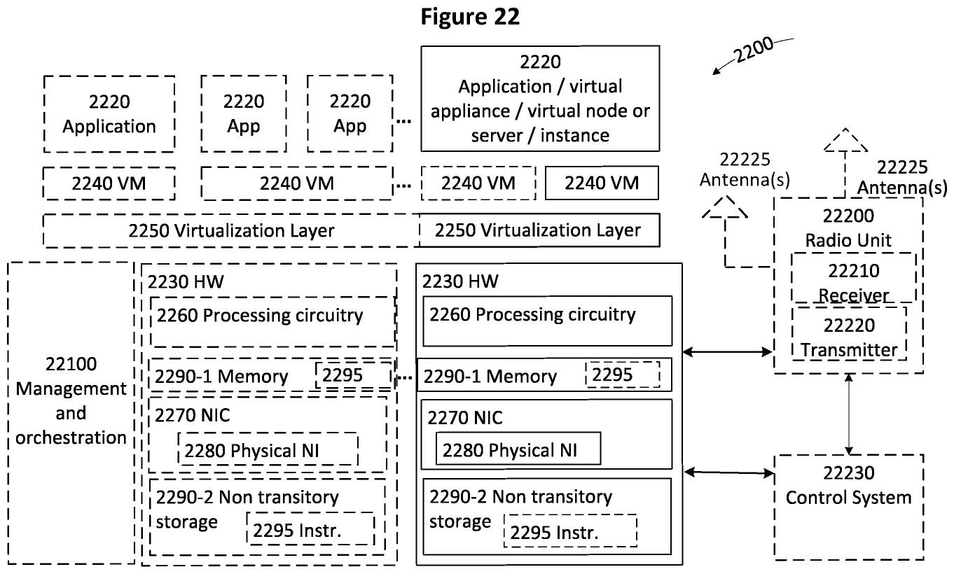

FIG. 22 illustrates a virtualization environment in accordance with some embodiments.

FIG. 22 is a schematic block diagram illustrating a virtualization environment 2200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2200 hosted by one or more of hardware nodes 2230. Further, in embodiments in which the virtual node is not a radio access node or does not require radio connectivity (e.g., a core network node), then the network node may be entirely virtualized.

The functions may be implemented by one or more applications 2220 (which may alternatively be called software instances, virtual appliances, network functions, virtual nodes, virtual network functions, etc.) operative to implement some of the features, functions, and/or benefits of some of the embodiments disclosed herein. Applications 2220 are run in virtualization environment 2200 which provides hardware 2230 comprising processing circuitry 2260 and memory 2290. Memory 2290 contains instructions 2295 executable by processing circuitry 2260 whereby application 2220 is operative to provide one or more of the features, benefits, and/or functions disclosed herein.

Virtualization environment 2200, comprises general-purpose or special-purpose network hardware devices 2230 comprising a set of one or more processors or processing circuitry 2260, which may be commercial off-the-shelf (COTS) processors, dedicated Application Specific Integrated Circuits (ASICs), or any other type of processing circuitry including digital or analog hardware components or special purpose processors. Each hardware device may comprise memory 2290-1 which may be non-persistent memory for temporarily storing instructions 2295 or software executed by processing circuitry 2260. Each hardware device may comprise one or more network interface controllers (NICs) 2270, also known as network interface cards, which include physical network interface 2280. Each hardware device may also include non-transitory, persistent, machine-readable storage media 2290-2 having stored therein software 2295 and/or instructions executable by processing circuitry 2260. Software 2295 may include any type of software including software for instantiating one or more virtualization layers 2250 (also referred to as hypervisors), software to execute virtual machines 2240 as well as software allowing it to execute functions, features and/or benefits described in relation with some embodiments described herein.

Virtual machines 2240, comprise virtual processing, virtual memory, virtual networking or interface and virtual storage, and may be run by a corresponding virtualization layer 2250 or hypervisor. Different embodiments of the instance of virtual appliance 2220 may be implemented on one or more of virtual machines 2240, and the implementations may be made in different ways.

During operation, processing circuitry 2260 executes software 2295 to instantiate the hypervisor or virtualization layer 2250, which may sometimes be referred to as a virtual machine monitor (VMM). Virtualization layer 2250 may present a virtual operating platform that appears like networking hardware to virtual machine 2240.

As shown in FIG. 22, hardware 2230 may be a standalone network node with generic or specific components. Hardware 2230 may comprise antenna 22225 and may implement some functions via virtualization. Alternatively, hardware 2230 may be part of a larger cluster of hardware (e.g. such as in a data center or customer premise equipment (CPE)) where many hardware nodes work together and are managed via management and orchestration (MANO) 22100, which, among others, oversees lifecycle management of applications 2220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2240 may be a software implementation of a physical machine that runs programs as if they were executing on a physical, non-virtualized machine. Each of virtual machines 2240, and that part of hardware 2230 that executes that virtual machine, be it hardware dedicated to that virtual machine and/or hardware shared by that virtual machine with others of the virtual machines 2240, forms a separate virtual network elements (VNE).

Still in the context of NFV, Virtual Network Function (VNF) is responsible for handling specific network functions that run in one or more virtual machines 2240 on top of hardware networking infrastructure 2230 and corresponds to application 2220 in FIG. 22.

In some embodiments, one or more radio units 22200 that each include one or more transmitters 22220 and one or more receivers 22210 may be coupled to one or more antennas 22225. Radio units 22200 may communicate directly with hardware nodes 2230 via one or more appropriate network interfaces and may be used in combination with the virtual components to provide a virtual node with radio capabilities, such as a radio access node or a base station.

In some embodiments, some signalling can be effected with the use of control system 22230 which may alternatively be used for communication between the hardware nodes 2230 and radio units 22200.

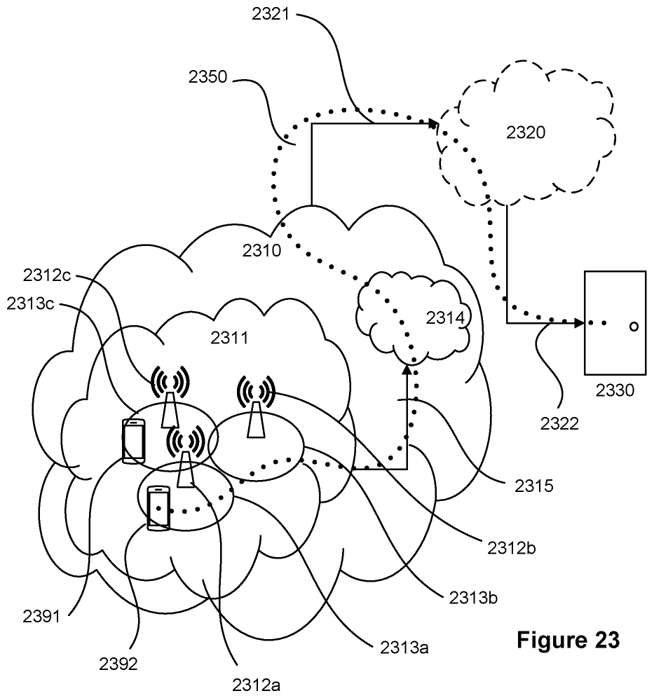

FIG. 23 illustrates a telecommunication network connected via an intermediate network to a host computer in accordance with some embodiments.

With reference to FIG. 23, in accordance with an embodiment, a communication system includes telecommunication network 2310, such as a 3GPP-type cellular network, which comprises access network 2311, such as a radio access network, and core network 2314. Access network 2311 comprises a plurality of base stations 2312a, 2312b, 2312c, such as NBs, eNBs, gNBs or other types of wireless access points, each defining a corresponding coverage area 2313a, 2313b, 2313c. Each base station 2312a, 2312b, 2312c is connectable to core network 2314 over a wired or wireless connection 2315. A first UE 2391 located in coverage area 2313c is configured to wirelessly connect to, or be paged by, the corresponding base station 2312c. A second UE 2392 in coverage area 2313a is wirelessly connectable to the corresponding base station 2312a. While a plurality of UEs 2391, 2392 are illustrated in this example, the disclosed embodiments are equally applicable to a situation where a sole UE is in the coverage area or where a sole UE is connecting to the corresponding base station 2312.

Telecommunication network 2310 is itself connected to host computer 2330, which may be embodied in the hardware and/or software of a standalone server, a cloud-implemented server, a distributed server or as processing resources in a server farm. Host computer 2330 may be under the ownership or control of a service provider, or may be operated by the service provider or on behalf of the service provider. Connections 2321 and 2322 between telecommunication network 2310 and host computer 2330 may extend directly from core network 2314 to host computer 2330 or may go via an optional intermediate network 2320. Intermediate network 2320 may be one of, or a combination of more than one of, a public, private or hosted network; intermediate network 2320, if any, may be a backbone network or the Internet; in particular, intermediate network 2320 may comprise two or more sub-networks (not shown).

The communication system of FIG. 23 as a whole enables connectivity between the connected UEs 2391, 2392 and host computer 2330. The connectivity may be described as an over-the-top (OTT) connection 2350. Host computer 2330 and the connected UEs 2391, 2392 are configured to communicate data and/or signaling via OTT connection 2350, using access network 2311, core network 2314, any intermediate network 2320 and possible further infrastructure (not shown) as intermediaries. OTT connection 2350 may be transparent in the sense that the participating communication devices through which OTT connection 2350 passes are unaware of routing of uplink and downlink communications. For example, base station 2312 may not or need not be informed about the past routing of an incoming downlink communication with data originating from host computer 2330 to be forwarded (e.g., handed over) to a connected UE 2391. Similarly, base station 2312 need not be aware of the future routing of an outgoing uplink communication originating from the UE 2391 towards the host computer 2330.

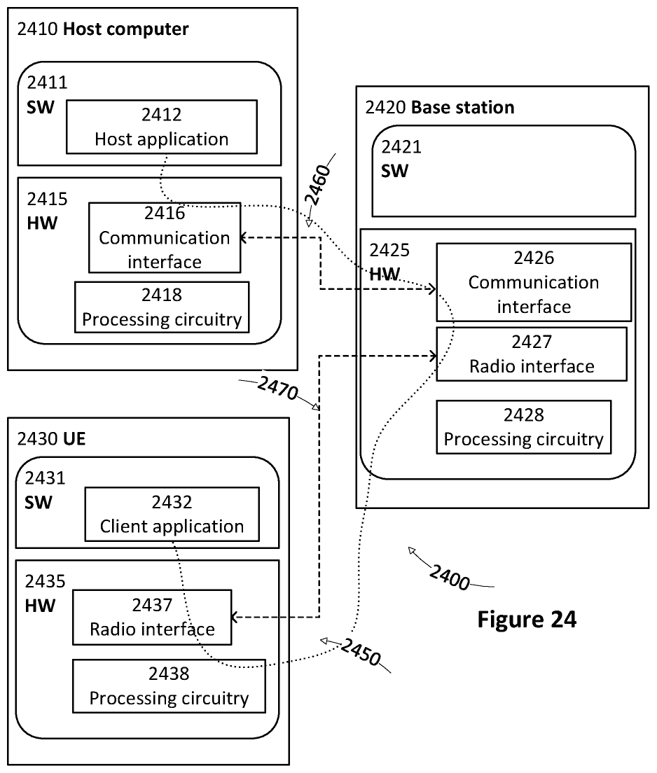

FIG. 24 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 24. In communication system 2400, host computer 2410 comprises hardware 2415 including communication interface 2416 configured to set up and maintain a wired or wireless connection with an interface of a different communication device of communication system 2400. Host computer 2410 further comprises processing circuitry 2418, which may have storage and/or processing capabilities. In particular, processing circuitry 2418 may comprise one or more programmable processors, application-specific integrated circuits, field programmable gate arrays or combinations of these (not shown) adapted to execute instructions. Host computer 2410 further comprises software 2411, which is stored in or accessible by host computer 2410 and executable by processing circuitry 2418. Software 2411 includes host application 2412. Host application 2412 may be operable to provide a service to a remote user, such as UE 2430 connecting via OTT connection 2450 terminating at UE 2430 and host computer 2410. In providing the service to the remote user, host application 2412 may provide user data which is transmitted using OTT connection 2450.

Communication system 2400 further includes base station 2420 provided in a telecommunication system and comprising hardware 2425 enabling it to communicate with host computer 2410 and with UE 2430. Hardware 2425 may include communication interface 2426 for setting up and maintaining a wired or wireless connection with an interface of a different communication device of communication system 2400, as well as radio interface 2427 for setting up and maintaining at least wireless connection 2470 with UE 2430 located in a coverage area (not shown in FIG. 24) served by base station 2420. Communication interface 2426 may be configured to facilitate connection 2460 to host computer 2410. Connection 2460 may be direct or it may pass through a core network (not shown in FIG. 24) of the telecommunication system and/or through one or more intermediate networks outside the telecommunication system. In the embodiment shown, hardware 2425 of base station 2420 further includes processing circuitry 2428, which may comprise one or more programmable processors, application-specific integrated circuits, field programmable gate arrays or combinations of these (not shown) adapted to execute instructions. Base station 2420 further has software 2421 stored internally or accessible via an external connection.

Communication system 2400 further includes UE 2430 already referred to. Its hardware 2435 may include radio interface 2437 configured to set up and maintain wireless connection 2470 with a base station serving a coverage area in which UE 2430 is currently located. Hardware 2435 of UE 2430 further includes processing circuitry 2438, which may comprise one or more programmable processors, application-specific integrated circuits, field programmable gate arrays or combinations of these (not shown) adapted to execute instructions. UE 2430 further comprises software 2431, which is stored in or accessible by UE 2430 and executable by processing circuitry 2438. Software 2431 includes client application 2432. Client application 2432 may be operable to provide a service to a human or non-human user via UE 2430, with the support of host computer 2410. In host computer 2410, an executing host application 2412 may communicate with the executing client application 2432 via OTT connection 2450 terminating at UE 2430 and host computer 2410. In providing the service to the user, client application 2432 may receive request data from host application 2412 and provide user data in response to the request data. OTT connection 2450 may transfer both the request data and the user data. Client application 2432 may interact with the user to generate the user data that it provides.

It is noted that host computer 2410, base station 2420 and UE 2430 illustrated in FIG. 24 may be similar or identical to host computer 2330, one of base stations 2312a, 2312b, 2312c and one of UEs 2391, 2392 of FIG. 23, respectively. This is to say, the inner workings of these entities may be as shown in FIG. 24 and independently, the surrounding network topology may be that of FIG. 23.

In FIG. 24, OTT connection 2450 has been drawn abstractly to illustrate the communication between host computer 2410 and UE 2430 via base station 2420, without explicit reference to any intermediary devices and the precise routing of messages via these devices. Network infrastructure may determine the routing, which it may be configured to hide from UE 2430 or from the service provider operating host computer 2410, or both. While OTT connection 2450 is active, the network infrastructure may further take decisions by which it dynamically changes the routing (e.g., on the basis of load balancing consideration or reconfiguration of the network).

Wireless connection 2470 between UE 2430 and base station 2420 is in accordance with the teachings of the embodiments described throughout this disclosure. One or more of the various embodiments may improve the performance of OTT services provided to UE 2430 using OTT connection 2450, in which wireless connection 2470 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 2450 between host computer 2410 and UE 2430, in response to variations in the measurement results. The measurement procedure and/or the network functionality for reconfiguring OTT connection 2450 may be implemented in software 2411 and hardware 2415 of host computer 2410 or in software 2431 and hardware 2435 of UE 2430, or both. In embodiments, sensors (not shown) may be deployed in or in association with communication devices through which OTT connection 2450 passes; the sensors may participate in the measurement procedure by supplying values of the monitored quantities exemplified above, or supplying values of other physical quantities from which software 2411, 2431 may compute or estimate the monitored quantities. The reconfiguring of OTT connection 2450 may include message format, retransmission settings, preferred routing etc.; the reconfiguring need not affect base station 2420, and it may be unknown or imperceptible to base station 2420. Such procedures and functionalities may be known and practiced in the art. In certain embodiments, measurements may involve proprietary UE signaling facilitating host computer 2410's measurements of throughput, propagation times, latency and the like. The measurements may be implemented in that software 2411 and 2431 causes messages to be transmitted, in particular empty or ‘dummy’ messages, using OTT connection 2450 while it monitors propagation times, errors etc.

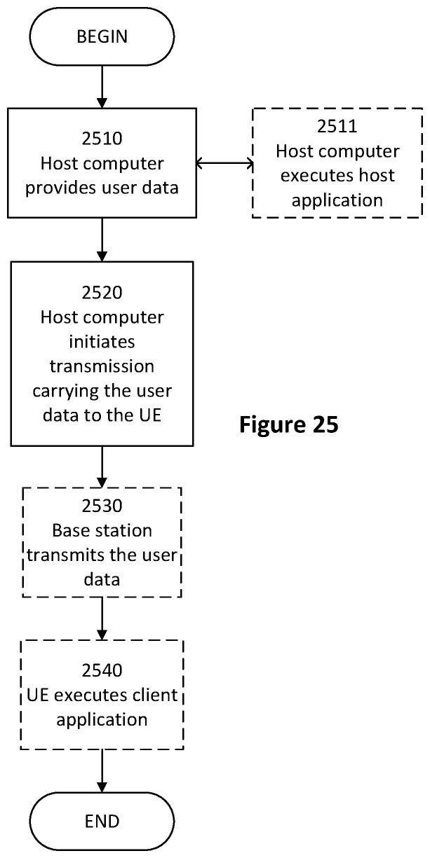

FIG. 25 illustrates methods implemented in a communication system including a host computer, a base station and a user equipment in accordance with some embodiments

FIG. 25 is a flowchart illustrating a method implemented in a communication system, in accordance with one embodiment. The communication system includes a host computer, a base station and a UE which may be those described with reference to FIGS. 23 and 24. For simplicity of the present disclosure, only drawing references to FIG. 25 will be included in this section. In step 2510, the host computer provides user data. In substep 2511 (which may be optional) of step 2510, the host computer provides the user data by executing a host application. In step 2520, the host computer initiates a transmission carrying the user data to the UE. In step 2530 (which may be optional), the base station transmits to the UE the user data which was carried in the transmission that the host computer initiated, in accordance with the teachings of the embodiments described throughout this disclosure. In step 2540 (which may also be optional), the UE executes a client application associated with the host application executed by the host computer.

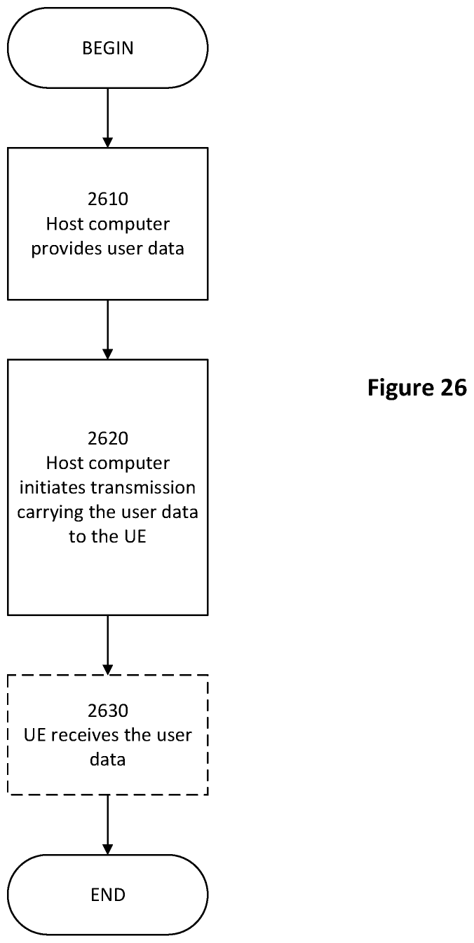

FIG. 26 illustrates methods implemented in a communication system including a host computer, a base station and a user equipment in accordance with some embodiments.

FIG. 26 is a flowchart illustrating a method implemented in a communication system, in accordance with one embodiment. The communication system includes a host computer, a base station and a UE which may be those described with reference to FIGS. 23 and 24. For simplicity of the present disclosure, only drawing references to FIG. 26 will be included in this section. In step 2610 of the method, the host computer provides user data. In an optional substep (not shown) the host computer provides the user data by executing a host application. In step 2620, the host computer initiates a transmission carrying the user data to the UE. The transmission may pass via the base station, in accordance with the teachings of the embodiments described throughout this disclosure. In step 2630 (which may be optional), the UE receives the user data carried in the transmission.

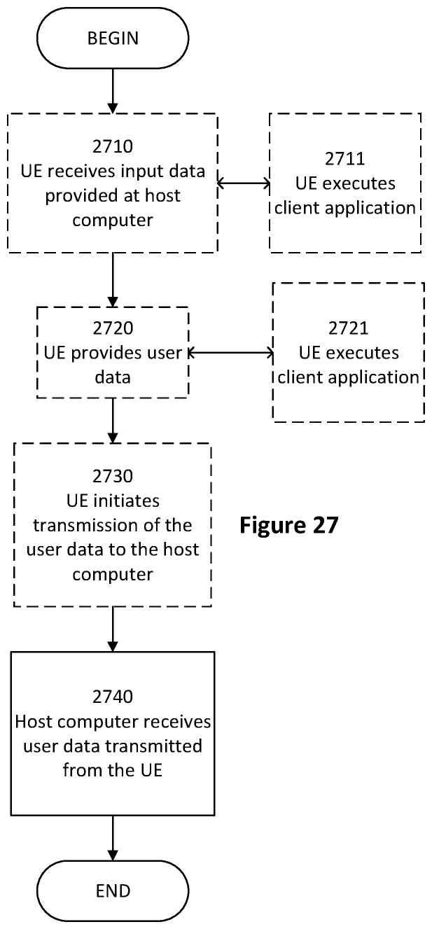

FIG. 27 illustrates methods implemented in a communication system including a host computer, a base station and a user equipment in accordance with some embodiments

FIG. 27 is a flowchart illustrating a method implemented in a communication system, in accordance with one embodiment. The communication system includes a host computer, a base station and a UE which may be those described with reference to FIGS. 23 and 24. For simplicity of the present disclosure, only drawing references to FIG. 27 will be included in this section. In step 2710 (which may be optional), the UE receives input data provided by the host computer. Additionally or alternatively, in step 2720, the UE provides user data. In substep 2721 (which may be optional) of step 2720, the UE provides the user data by executing a client application. In substep 2711 (which may be optional) of step 2710, the UE executes a client application which provides the user data in reaction to the received input data provided by the host computer. In providing the user data, the executed client application may further consider user input received from the user. Regardless of the specific manner in which the user data was provided, the UE initiates, in substep 2730 (which may be optional), transmission of the user data to the host computer. In step 2740 of the method, the host computer receives the user data transmitted from the UE, in accordance with the teachings of the embodiments described throughout this disclosure.

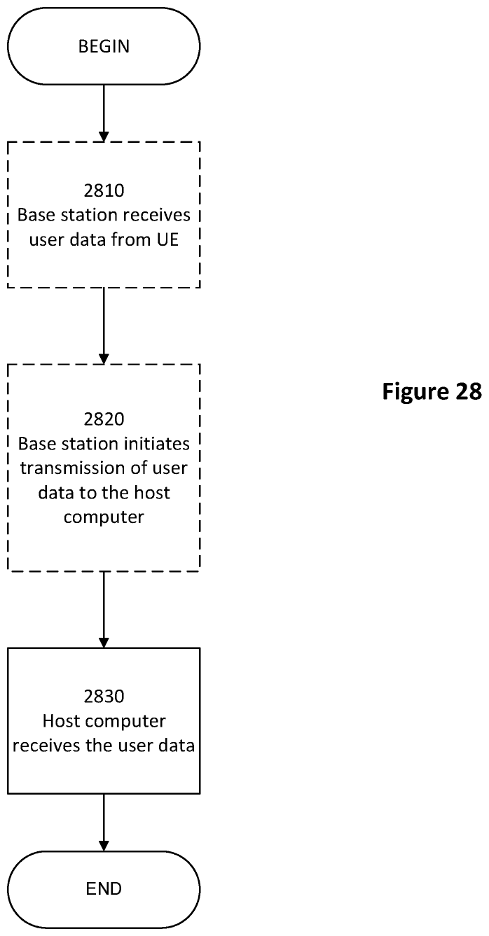

FIG. 28 illustrates methods implemented in a communication system including a host computer, a base station and a user equipment in accordance with some embodiments

FIG. 28 is a flowchart illustrating a method implemented in a communication system, in accordance with one embodiment. The communication system includes a host computer, a base station and a UE which may be those described with reference to FIGS. 23 and 24. For simplicity of the present disclosure, only drawing references to FIG. 28 will be included in this section. In step 2810 (which may be optional), in accordance with the teachings of the embodiments described throughout this disclosure, the base station receives user data from the UE. In step 2820 (which may be optional), the base station initiates transmission of the received user data to the host computer. In step 2830 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

1× RTT CDMA2000 1× Radio Transmission Technology

3GPP 3rd Generation Partnership Project

5G 5th Generation

ABS Almost Blank Subframe

ACK Acknowledgement

AP Application Protocol

ARQ Automatic Repeat Request

AWGN Additive White Gaussian Noise

BCCH Broadcast Control Channel

BCH Broadcast Channel

BSR Buffer Status Report

CA Carrier Aggregation

CC Carrier Component

CCCH SDU Common Control Channel SDU

CDMA Code Division Multiplexing Access

CE Control Element

CGI Cell Global Identifier

CIR Channel Impulse Response

CP Control Plane

CP Cyclic Prefix

CPICH Common Pilot Channel

CQI Channel Quality information

C-RNTI Cell RNTI

CSI Channel State Information

DC Dual Connectivity

DCCH Dedicated Control Channel

DCI Downlink Control Information

DL Downlink

DM Demodulation

DMRS Demodulation Reference Signal

DoNAS Data Over NAS

DRB Data Radio Bearer

DRX Discontinuous Reception

DTX Discontinuous Transmission

DTCH Dedicated Traffic Channel

DUT Device Under Test

E-CID Enhanced Cell-ID (positioning method)

E-RAB EUTRAN Radio Access Bearer

E-SMLC Evolved-Serving Mobile Location Centre

ECGI Evolved CGI

eNB E-UTRAN NodeB

ePDCCH enhanced Physical Downlink Control Channel

E-SMLC evolved Serving Mobile Location Center

E-UTRA Evolved UTRA

E-UTRAN Evolved UTRAN

FDD Frequency Division Duplex

FFS For Further Study

GERAN GSM EDGE Radio Access Network

gNB Base station in NR

GNSS Global Navigation Satellite System

GSM Global System for Mobile communication

GTP-UGPRS Tunneling Protocol—User Plane

HARQ Hybrid Automatic Repeat Request

HO Handover

HSPA High Speed Packet Access

HRPD High Rate Packet Data

IE Information Element

IoT Internet of Things

IP Internet Protocol

LOS Line of Sight

LPP LTE Positioning Protocol

LTE Long-Term Evolution

MAC Medium Access Control

MBMS Multimedia Broadcast Multicast Services

MBSFN Multimedia Broadcast multicast service Single Frequency Network

MBSFN ABS MBSFN Almost Blank Subframe

MCG Master Cell Group

MDT Minimization of Drive Tests

MeNB Master eNB

MgNB Master gNB

MIB Master Information Block

MME Mobility Management Entity

MN Master Node

MSC Mobile Switching Center

NACK Negative Acknowledgement

NAS Non-Access Stratum

NB-IoT Narrowband Internet of Things

NPDCCH Narrowband Physical Downlink Control Channel

NR New Radio

OCNG OFDMA Channel Noise Generator

OFDM Orthogonal Frequency Division Multiplexing

OFDMA Orthogonal Frequency Division Multiple Access

OSS Operations Support System

OTDOA Observed Time Difference of Arrival

O&M Operation and Maintenance

PBCH Physical Broadcast Channel

P-CCPCH Primary Common Control Physical Channel

PCell Primary Cell

PCFICH Physical Control Format Indicator Channel

PCI Physical Cell Identity

PDCCH Physical Downlink Control Channel

PDCP Packet Data Convergence Protocol

PDP Profile Delay Profile

PDSCH Physical Downlink Shared Channel

PGW Packet Gateway

PHICH Physical Hybrid-ARQ Indicator Channel

PLMN Public Land Mobile Network

PMI Precoder Matrix Indicator

PRACH Physical Random Access Channel

PRS Positioning Reference Signal

PSS Primary Synchronization Signal

PUCCH Physical Uplink Control Channel

PUSCH Physical Uplink Shared Channel

RACH Random Access Channel

QAM Quadrature Amplitude Modulation

RAN Radio Access Network

RAT Radio Access Technology

RLC Radio Link Control

RLF Radio Link Failure

RLM Radio Link Management

RNC Radio Network Controller

RNTI Radio Network Temporary Identifier

RRC Radio Resource Control

RRM Radio Resource Management

RS Reference Signal

RSCP Received Signal Code Power

RSRP Reference Symbol Received Power OR Reference Signal Received Power

RSRQ Reference Signal Received Quality OR Reference Symbol Received Quality

RSSI Received Signal Strength Indicator

RSTD Reference Signal Time Difference

SCH Synchronization Channel

SCell Secondary Cell

SCG Secondary Cell Group

SCTP Stream Control Transmission Protocol

SDU Service Data Unit

SeNB Secondary eNB

SFN System Frame Number

SGW Serving Gateway

SI System Information

SIB System Information Block

SN Secondary Node

SNR Signal to Noise Ratio

SON Self Optimized Network

SR Scheduling Request

SRB Signaling Radio Bearer

SS Synchronization Signal

SSS Secondary Synchronization Signal

TDD Time Division Duplex

TDOA Time Difference of Arrival

TEID Tunnel Endpoint IDentifier

TMSI Temporary Mobile Subscriber Identity

TNL Transport Network Layer

TOA Time of Arrival

TSS Tertiary Synchronization Signal

TTI Transmission Time Interval

UCI Uplink Control Information

UDP User Datagram Protocol

UE User Equipment

UL Uplink

UMTS Universal Mobile Telecommunication System

UP User Plane

URLLC Ultra Reliable Low Latency Communication

USIM Universal Subscriber Identity Module

UTDOA Uplink Time Difference of Arrival

UTRA Universal Terrestrial Radio Access

UTRAN Universal Terrestrial Radio Access Network

WCDMA Wide CDMA

WLAN Wide Local Area Network

X2 Interface between base stations

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a wireless device in a communication network, comprising:
receiving a message that indicates to the wireless device to enter a dormant state, wherein the message comprises a configuration;
determining that the wireless device is unable to comply with the configuration included in the message; and
responsive to determining that the wireless device is unable to comply with the configuration included in the message, performing a recovery action.

2. The method of claim 1, wherein the message comprises at least one of a RRCRelease message and a RRCConnectionRelease message.

3. The method of any of claim 1, wherein the configuration refers to a procedure to be performed while the UE is in dormant state.

4. The method of any of claim 1, wherein the configuration refers to a field that is associated with an information element included in the message, wherein the field comprises at least one of: redirectedCarrierinfo of IE RedirectedCarrierinfo; cellReselectionPriorities of IE CellReselectionPriorities; suspendConfig of IE SuspendConfig; deprioritisationReq of IE SEQUENCE {deprioritisationType ENUMERATED {frequency, nr}, deprioritisationTimer of IE ENUMERATED {min5, min10, min15, min30} }; measIdleConfig of IE MeasldleConfigDedicated; and/or any other configuration received in the message.

5. The method of claim 1, wherein the configuration comprises at least one of: a measurement configuration for idle state measurements, a cell reselection configuration, a redirected carrier configuration, a suspend configuration, and a deprioritisation type configuration.

6. The method of claim 1, wherein the dormant state comprises at least one of: RRC_INACTIVE state; RRC_IDLE state; RRC_IDLE state with a stored context, any other state designed mainly for power savings at the UE; and/or any other state where the UE performs cell reselection.

7. The method of claim 1, wherein determining that the wireless device is unable to comply with the configuration included in the configuration included in the message comprises determining that the wireless device is unable to comply with a portion of the configuration included in the message.

8. The method of claim 1, wherein the message comprises a plurality of configurations that comprise respective fields and information elements, and wherein determining that the wireless device is unable to comply with the configuration included in the message comprises determining that the wireless device is unable to comply with one of the fields and/or information elements in at least one of the plurality of configurations.

9. The method of claim 1, wherein the recovery action comprises at least one of: performing an action upon going to RRC_IDLE state;
determining a release cause associated to a failure that is indicated to upper layers; responsive to a failure indication as release cause, triggering, by the upper layers, a recovery procedure in which the wireless device enters IDLE state and attempts to enter CONNECTED state via an RRC Connection Establishment; and initiating a connection re-establishment procedure, wherein the failure comprises at least one of a suspend failure; a release failure; a resume failure; and a reconfiguration failure.

10. The method of claim 1, wherein receiving the message is performed while the wireless device is in RRC_CONNECTED state, and wherein performing the recovery action is based on determining whether access stratum, AS, security has been activated;
wherein responsive to determining that AS security has not been activated, the recovery action is performed upon going to RRC_IDLE state; and
wherein responsive to determining that AS security has been activated and that a signalling radio bearer and at least one data radio bearer have not been setup, the recovery action is performed upon going to RRC_IDLE state with a release cause indicating a failure.

11. The method of claim 10, further comprising initiating a connection re-establishment procedure in response to determining that AS has been activated and that at least one data radio bearer has been set up.

12. The method of claim 1, wherein receiving the message is performed while the wireless device is in RRC_INACTIVE state.

13. The method of claim 1, wherein the message causes a protocol error at the wireless device that corresponds to a generic error handling procedure that specifies that the wireless device ignore the message.

14. The method of claim 1, wherein responsive to the wireless device being unable to comply with any part of the configuration included in the message, the wireless device does not apply any of the configuration.

15. The method of claim 1, wherein, responsive to the wireless device being unable to comply with a portion of the configuration included in the message, applying a portion of the configuration that the wireless device can comply with and logging an indication regarding which portion of the configuration that the wireless device cannot comply with.

16. The method of claim 15, further comprising causing a message to be sent to the communication network that includes an identity of the portion of the configuration that the wireless device cannot comply during and/or after a recovery operation.

17. A method of operating a wireless network node, comprising:
transmitting a message that indicates to a wireless device to enter a dormant state, where the message comprises a configuration; and
receiving an indication from the wireless device that it is unable to comply with at least a part of the configuration included in the message.

18. The method of claim 17, further comprising:
refraining from setting the configuration in the wireless device in connection with a subsequent suspend or release procedure for the wireless device.

19. The method of claim 17, wherein the network node comprises a radio access network node or a core network node.

20. A method of operating a wireless device that has established a radio resource control, RRC, connection with a network node in a communication network and operating in CONNECTED state, the method comprising:
receiving an RRC release message from the network node, instructing the wireless device to transition to a dormant state, the RRC release message including a configuration containing one or more of: a configuration related to performing/reporting of early measurements;
a configuration related to suspension/resumption of the connection; and/or a configuration related to redirection to other cells/frequencies.

21-45. (canceled)
